(19) United States
(12) Patent Application Publication
(10) Pub. No.: US 2026/0264654 A1
(43) Pub. Date: Sep. 10, 2026

(54) DRIVING DYNAMICS SYSTEM FOR A VEHICLE HAVING WHEELS, AND METHOD FOR ADJUSTING A BRAKE PRESSURE

(71) Applicant: IPGATE AG, Pfaffikon (CH)

(72) Inventor: Thomas LEIBER, Rogoznica (HR)

(21) Appl. No.: 18/877,206

(22) PCT Filed: Jun. 29, 2023
(86) PCT No.: PCT/EP2023/067851

§ 371 Date: Dec. 19, 2024

(30) Foreign Application Priority Data
Jun. 30, 2022 (DE) 10 2022 116 353.9

(51) Int. Cl. B60T 13/66; B60T 13/74; B60T 17/22

(52) U.S. Cl. CPC B60T 13/662; B60T 13/745; B60T 17/221; B60T 2270/403; B60T 2270/413

(57) ABSTRACT

A driving dynamics system for a vehicle may include a primary control unit for detecting and/or generating steering commands and brake commands; hydraulically actuatable wheel brakes which are each associated with one wheel; at least one electrical traction motor having a traction-motor control unit, the traction motor being provided to drive at least one of the wheels. The primary control unit is communicatively connected to the traction-motor control unit to control the traction motor to implement steering and brake commands. The system may further include at least one electrohydraulic pressure supply unit. A brake-pressure adjustment valve that is a special solenoid valve that can be shut tight, and an outlet valve, are associated with at least one of the hydraulically actuatable wheel brakes. The driving dynamics system may relieve pressure from at least one hydraulically actuatable wheel brake selectively via the associated outlet valve or the special solenoid valve.

### CROSS REFERENCE TO RELATED APPLICATION

This application is a Section 371 of International Application No. PCT/EP2023/067851, filed Jun. 29, 2023, which was published on Jan. 4, 2024 under International Publication No. WO 2024/003262, which claims priority under 35 U.S.C. § 119 (b) to German Patent Application No. 10 2022 116 353.9, filed Jun. 30, 2022, the disclosures of which are incorporated herein by reference in their entireties.

### Designation

The present Invention relates to a driving dynamics system (FDS) having a primary control unit or a central computer (M-ECU) according to the preamble of claim 1 and a method for adjusting a brake pressure.

### DESCRIPTION OF THE PRIOR ART

Since the market launch of the anti-lock braking system (ABS), traction control system (TCS) and the electronic stability program (ESP) in 1978, 1986 and 1995, brake pressure control systems for the electrohydraulic brake (EHB) based on the return principle with pre-pressure via a master brake cylinder have become established. Here, pressure build-up is throttled with PWM via inlet valves and pressure reduction via time control of the outlet valves. The valve block, electric motor, pump, accumulator chamber, eight solenoid valves (for ABS) or twelve solenoid valves (for ESP), pressure sensor and electronic control unit (ECU) are usually combined in a single unit and installed separately from the brake booster (BB) in the engine compartment.

The use of ABS/ESP motor-pump units in combination with vacuum brake boosters and vacuum pumps is most common in existing vehicles on the market. So-called 2-box brake systems with electro-hydraulic brake booster and spatially separated ESP unit (DE102012211278A1) and so-called 1-box brake systems with integrated brake booster and pressure modulation (EP1907253B1, DE102013222281A1) are standard in new vehicles.

The hydraulic design of the ESP unit with twelve solenoid valves as a pressure supply unit has not changed since the series introduction in 1995, but a standardized interface (see VDA 360) was specified for the interaction between the control unit of an electric brake booster and the control unit of the ESP unit for additional functions and for component protection of a rigid electromechanical brake booster. For example, solenoid valves of the ESP unit are activated for certain functions via the control device. DE102012211278A1 describes the control of valves and the ABS pump for recuperative braking.

The automotive industry is undergoing a major change process. In addition to the Increasing market penetration of electric vehicles, various stages of automated driving (SAE levels 2-5) are being passed through, wherein each stage of autonomous driving increases the redundancy requirements for the braking systems used (see ATZ article 3/2019 “Brake boosters for automated driving”).

In addition, the central control of a vehicle with control units for chassis control (hereinafter referred to as “Vehicle Motion Control” or “VMC” or “Vehicle Chassis Control” or “VCC”) is introduced, which includes the electrohydraulic brake, electrical traction motors™ on one or more axles of a vehicle, the electric power steering (EPS) and optionally also the damping. Synergies can be exploited thanks to the central control system.

For the first time since 2020, recuperative braking with powerful electrical traction motors in the “Formula E” racing series does not follow the “blending strategy” defined as standard in the 5th edition of the brake manual (see chapter 19: “Regenerative braking systems”), in which the hydraulic braking torque is reduced by the braking torque of the electrical traction motor. Instead, a braking torque is generated additively by an electrical traction motor and by the electrohydraulic brake in order to achieve a reduction in the time required to reach the blocking braking torque/blocking braking pressure (TTL for short). This shortens the braking distance by building up braking torque as quickly as possible.

### Current Limitations and Problems of ABS/ESP Systems According to the Prior Art

One problem with current ABS/ESP brake systems with a motor-pump unit is the limited dynamics for new functionalities, such as the automatic emergency brake (AEB). For this function, it is very important to build up the brake pressure to the wheel lock pressure (typical values in passenger car brake systems: 80-100 bar) in the shortest possible time. While the ABS/ESP brake system with its pump and electric brush motor achieves a pressure of 50 bar in 450 ms, 1-box brake systems with a powerful brushless motor (DE102005063659B3) can achieve a wheel lock pressure of 80-100 bar in less than 150 ms. Short TTL times can mean a reduction in braking distance of more than 5 meters at an initial speed of 65 km/h.

Every ABS/ESP brake system (ABS/ESP brake system with motor-pump unit and 1-box) has non-return valves as a matter of principle, which are connected hydraulically in parallel to the inlet valves in the hydraulic lines to the wheel brakes for safety reasons and ensure that the pressure in the wheel brakes is always automatically reduced, i.e. if the pressure supply fails, no pressure remains in the wheel brakes. However, this technical solution means that a wheel brake circuit failure is difficult or impossible to diagnose because it is unclear whether a non-return valve or the inlet valve is the cause of the wheel circuit failure. As a result, an entire brake circuit with two-wheel brakes must be deactivated in the event of a fault. This is why the diagonal brake circuit layout (X brake circuit) is the preferred layout in the majority of vehicles, because in the event of brake circuit failure it is still possible to brake with a front wheel brake with a greater braking effect than a rear wheel brake. The so-called “black/white” brake circuit distribution (II brake circuit) is used in hybrid or electric vehicles with the disadvantage of poor braking effect in the event of a failure, but the advantage of simpler implementation of control strategies for recuperative braking.

Furthermore, an ABS/ESP brake system with a motor-pump unit with pressure reduction via time-controlled outlet valves into the accumulator chamber has disadvantages in terms of braking distance control performance compared to the above-mentioned 1-box brake systems (see DE102013222281A1) with pressure reduction into the reservoir, because during pressure reduction the back pressure in the accumulator chamber (up to 5 bar) limits rapid pressure reduction at low pressures. In the case of ABS control on roads with low friction coefficients low-u (snow & ice), this leads to a slow pressure reduction and the wheel speed drops during ABS control are therefore very long. This leads to a long braking distance. In some cases, ABS can only be controlled rudimentarily on roads with extremely low coefficients of friction (ice). As a result, standard ABS/ESP systems have a further significant disadvantage in braking distance compared to the new standard set with 1-box brake systems, even in regular operation, due to poorer control performance.

### OBJECT OF THE INVENTION

It is the object of the invention to provide an improved driving dynamics system, in particular in the form of a plurality of pressure supply units (2-box solution with two hydraulic pressure supply units connected in series in two separate hydraulic pressure supply units, separate pressure actuators for two-wheel brakes in each case). Preferably, the system should solve the above-mentioned problems. The system should be small, reliable, precise, safe and highly efficient.

The driving dynamics system should also meet the requirements of autonomous driving operation (SAE level 3, 4 with driver request detection via an e-pedal or SAE level 5 without pedal with setpoint specification by a central computer) and new interfaces between brake modules or pressure supply units and/or brake module and central computer should be created.

Furthermore, the system should make it possible to efficiently offer driving dynamics control functions (ABS, ESP, EBD, ACC, AEB, Recu-Mgt) and wheel-specific braking torque interventions (BtS: Brake-to-Steer, BtTV: Brake-to-Torque Vectoring) with the integration of at least one electrical traction motor.

Solution to the invention

This object may be solved by the subject matter according to various ones of the accompanying claims.

In particular, the object is solved by a driving dynamics system for a vehicle with wheels, which comprises:
a primary control unit for detecting and/or generating steering commands and braking commands;
at least two hydraulically actuatable wheel brakes which are each associated with one wheel;
at least one electrical traction motor having traction-motor control unit, wherein the traction motor is arranged to drive at least one of the wheels, wherein the primary control unit is communicatively connected to a traction-motor control unit in order to control the traction motor to Implement the steering commands and braking commands;
at least one (first) electrohydraulic pressure supply unit having
   at least one electric motor-pump unit:
   at least two connections for connecting the wheel brakes;
   electrically actuatable wheel brake pressure adjustment valves or brake pressure adjustment valves, and
   a first secondary control unit;
wherein at least one of the hydraulically actuatable wheel brakes (RB1-RB4) is associated with a brake pressure adjustment valve in the form of a special solenoid valve (MV2k), which is in particular passive-closure-proof, and an outlet valve, characterized in that

the driving dynamics system, in particular the primary control unit (M-ECU), is designed to relieve pressure from the at least one hydraulically actuatable wheel brake selectively via the associated outlet valve or via the special solenoid valve (MV2k).

In the first variant, the pressure reduction is preferably carried out exclusively via the respective outlet valve. In the second variant, an exclusive pressure reduction can be carried out via the respective special solenoid valve or simultaneously via the special solenoid valve and outlet valve.

Furthermore, the object is solved by a driving dynamics system comprising:
a primary control unit for detecting and/or generating steering commands and braking commands;
at least two hydraulically actuatable wheel brakes which are each associated with one wheel;
at least one electrical traction motor having traction-motor control unit, wherein the traction motor is arranged to drive at least one of the wheels, wherein the primary control unit is communicatively connected to a traction-motor control unit in order to control the traction motor to implement the steering commands and braking commands;
at least one (first) electrohydraulic pressure supply unit with
   at least one electric motor-pump unit:
   at least two connections for connecting the wheel brakes;
   electrically actuatable wheel brake pressure adjustment valves or brake pressure adjustment valves, and
   a first secondary control unit;
wherein at least one of the brake pressure adjustment valves comprises a special solenoid valve having an electromagnetic drive with a first excitation coll, via which a valve actuator or valve tappet can be adjusted between an open valve position and a closed valve position.

One inventive aspect is that the special solenoid valve has an additional force device which comprises a permanent magnet and/or a second excitation coil and which is arranged to provide at least one retaining force acting on the valve actuator or the valve tappet. Preferably, the special solenoid valves, which can be used as inlet valves or wheel inlet control valves, are made passive-closure-proof by this measure.

Thanks to a wheel brake circuit design with passive-closure-proof wheel inlet control valves, the system according to the invention is significantly more fail-safe than brake systems according to the prior art and a brake system with wheel circuits (wheel-specific pressure control and/or supply) can be implemented instead of conventional brake circuits with several wheels (diagonal or black and white). For example, the failure of a wheel circuit can be diagnosed, and the failed wheel circuit can be disconnected from the pressure supply by closing an Inlet valve. This means that, if one (individual) wheel circuit fails, significantly improved deceleration can be achieved with the remaining three-wheel circuits in the event of a fault, and yaw moment interventions can still be carried out on three wheels. In the following, brake modules of a first pressure supply unit with special solenoid valves according to claim 1 are referred to as ESP-X.

A steering command and/or braking command can be detected by the primary control unit via steering wheel sensors or force/displacement sensors on an electric brake pedal, for example. However, the primary control unit can also be designed to generate independent steering commands and braking commands. This is necessary in the course of autonomous driving. Corresponding commands can also be generated due to the implementation of a safety function (e.g. automatic emergency braking AEB). A steering command in the sense of the present invention does not mean the specific intervention of a driver by means of the steering wheel. Instead, the present invention understands a steering command to be any instruction that relates to the vehicle moving in a certain direction and also includes trajectory control in autonomous driving mode. For example, this also includes a command that leads to a change in the yaw moment. Torque vectoring can also be implemented using corresponding steering command and/or braking commands.

The (first) electrohydraulic pressure supply device can be an ABS/ESP unit. In general, however, this should be understood to mean any unit that has a pressure generator, for example in the form of the aforementioned motor-pump units and provides corresponding pressures at corresponding connections. The pressure supply unit can also perform regulating and/or control functions. It can therefore be a pressure control module.

One aspect of the invention is that the special solenoid valve provides an additional retention force. As a result, the special solenoid valve is passive-closure-proof and high pressures can be relieved via this valve. In addition to the retaining force, it can also be a restoring force that moves the valve actuator or the valve tappet into an open valve position.

In one embodiment, the primary control unit can be designed to control the special solenoid valve of the first pressure supply unit, at least in a selected braking mode, in such a way that pressure is released from the wheel brake assigned to the special solenoid valve when the special solenoid valve is open. Preferably, each special solenoid valve of the first pressure supply unit is assigned to a wheel brake. Due to the design where it is passive-closure-proof, the respective special solenoid valve can be used not only as an inlet valve, but also as a type of outlet valve. The pressure can be built up and released bidirectionally via the same special solenoid valve. This enables a (significantly) faster pressure reduction of the assigned wheel brake, because pressure can be released via several valves (special valve) as well as via the outlet valves. Furthermore, the pressure in the wheel brake can be maintained by closing the valve while the pressure generator is operated at low pressure while the pressure in the wheel brake is high. This provides new degrees of freedom, which are very advantageous in a central control strategy using the primary control unit.

In one embodiment, at least one of the wheel brakes associated with a special solenoid valve also has an outlet valve. The corresponding outlet valve can be assigned to the wheel brake. In one embodiment, the outlet valve and special solenoid valve are used simultaneously to reduce pressure in order to reduce the pressure in the respective wheel brake as quickly and effectively as possible. In particular, the primary control unit can be designed to control the associated special solenoid valve and outlet valve, at least in a selected braking mode, in such a way that brake fluid is simultaneously discharged from the wheel brake via the associated special solenoid valve and the associated outlet valve.

In one embodiment, the driving dynamics system has at least one second pressure supply unit. Preferably, this comprises a piston cylinder unit or a rotary pump—i.e. a separate pressure generator. The second pressure supply unit can be connected to at least one input of the first pressure supply unit to provide brake fluid. In one embodiment, the pressure supply unit not only performs a function in which it serves as a pressure reservoir, but also a function in which it is used as a (controllable/regulatable) pressure sink or alternatively has at least one valve for reducing the pressure (e.g. central outlet valve, see WO2020165259A1, outlet valves of an ABS/ESP unit). The pressure reduction can be time-controlled with valves, but can also be PWM-controlled if inlet valves of an ABS/ESP unit are used for the pressure reduction. If, for example, a piston-cylinder unit is used, a very low pressure, for example a pressure of 1 to 5 bar, can be generated by retracting the cylinder within the piston, wherein the existing pressure difference leads to a rapid pressure reduction in the wheel brakes. In a (preferred) embodiment, the pressure supply unit provides brake fluid for a first and a second brake circuit, wherein preferably at least one isolating valve is provided for isolating the first and/or the second brake circuit. As explained in more detail below, this isolating valve can be designed similarly or identically to the special solenoid valve already described.

Several first pressure supply units can also be provided and connected to the second pressure supply unit.

In one embodiment, the first pressure supply unit is (directly) connected to exactly two-wheel brakes. Preferably, these two-wheel brakes are associated with wheels which are located on a first axle. In one embodiment, in addition to the first pressure supply unit, at least one further pressure supply unit is provided, which is (directly) connected to at least two-wheel brakes on a second axle. In other words, the further pressure supply unit supplies two-wheel brakes which are associated with wheels located on the second axle. According to the invention, a plurality of first pressure supply units can thus be provided as different modules, wherein each module is associated with a specific axle or the wheel brakes on a specific axle. Depending on the vehicle, further axles with further pressure supply units may also be provided in addition to the first and second axles, wherein each pressure supply unit of an axle is preferably communicatively connected to the primary control unit for receiving steering commands and braking commands. According to the invention, a direct connection of a device to another device can be understood in such a way that a hydraulic connection is provided, for example via lines, which is not Interrupted by other devices, such as valves or pressure generators.

In one embodiment (hereinafter also referred to as valve connection variant I), the special solenoid valve is connected to the wheel brake with the armature chamber of the valve and the valve seat to the pressure supply unit, as is common in ABS/ESP systems according to the prior art and is designed to be open when de-energized. The pressure can be built up via a pre-pressure control and a PWM control of one or more of the special solenoid valves. Relief is carried out via a time control of the same valves, wherein there is no risk of the special solenoid valve being passively closed during pressure reduction due to the passive-closure-proof design.

In one (other) embodiment (valve connection variant II), the valve seat of at least one special solenoid valve is connected to the wheel brake. The arrangement enables the pressure to be released quietly in the respective wheel brake. Due to the arrangement, the valve opening cross-section can be adjusted, in particular by means of PWM control or current control. This allows a throttled pressure reduction via the special solenoid valve. In this embodiment, the pressure build-up via the special solenoid valve can take place via time control or volume measurement, which can be carried out in the second pressure supply unit, e.g. by adjusting the angle of rotation of a rotary pump or the piston travel of a piston-cylinder unit.

Both types of connection make it possible to disconnect a wheel brake from the system by simply closing it by energizing the special solenoid valve. A low holding current can be applied to hold the special solenoid valve closed. Disconnection can be advantageous if a defect, such as a leak, has been detected in the respective wheel brake.

In one embodiment, the first supply unit can comprise a rotary pump that is connected and designed to build up and release pressure in the wheel brakes. The rotary pump can therefore act as a pressure sink and implement a rapid pressure reduction.

Furthermore, the object is solved by a driving dynamics system comprising
a primary control unit for detecting and/or generating steering commands and braking commands;
four hydraulically actuatable wheel brakes which are each associated with wheels;
at least one electrical traction motor having traction-motor control unit, wherein the traction motor is arranged to drive at least one of the wheels of the vehicle, wherein the primary control unit is communicatively connected to a traction-motor control unit to control the traction motor to implement the steering commands and braking commands;
at least one first electrohydraulic pressure supply unit with
   at least one electric motor-pump unit:
   at least two connections for connecting the wheel brakes;
   electrically actuatable wheel brake pressure adjustment valves or brake pressure adjustment valves, and
   a first secondary control unit;
at least one second electrohydraulic pressure supply unit, which is arranged to provide brake fluid at at least one inlet of the first pressure supply unit for a first brake circuit and a second brake circuit, wherein at least one isolating valve in the form of a special solenoid valve for isolating the first and/or second brake circuit is assigned to the second pressure supply unit,
wherein the special solenoid valve comprises an electromagnetic drive with a first excitation coil, via which a valve actuator or valve tappet of the special solenoid valve can be adjusted between an open valve position and a closed valve position.

Alternatively, the object is solved by a system for a vehicle with wheels (R1-R4), in particular a driving dynamics system, in particular as described in a previous embodiment. The system may comprise:
a primary control unit (M-ECU) for detecting and/or generating steering commands and braking commands;
four hydraulically actuatable wheel brakes (RB1-RB4), which are each associated with wheels (R1-R4);
at least one electrical traction motor (TM1, TM2) with traction-motor control unit (S-ECU-TMHA), wherein the traction motor (TM1, TM2) is arranged to drive at least one of the wheels (R1-R4) of the vehicle, wherein the primary control unit (M-ECU) is communicatively connected to a traction-motor control unit to control the traction motor (TM1, TM2) to implement the steering commands and braking commands;
at least one first electrohydraulic pressure supply unit (BM1) with
   at least one electric motor-pump unit
   at least two connections for connecting the wheel brakes (RB1-RB4);
   electrically actuatable wheel brake pressure adjustment valves or brake pressure adjustment valves, and
   a first secondary control unit (S-ECU1);
at least one second electrohydraulic pressure supply unit (BM2), which is arranged to provide brake fluid at at least one inlet of the first pressure supply unit for a first brake circuit (BK1) and a second brake circuit (BK2),

wherein at least one isolating valve (TV1, TV2) in the form of a special solenoid valve (MV2k) for isolating the first and/or second brake circuit (BM1, BM2),

wherein the special solenoid valve (MV2k) comprises an electromagnetic drive with a first excitation coil (SP1a), via which a valve actuator (7) or valve tappet (7a) of the special solenoid valve (MV2k) can be adjusted between an open valve position and a closed valve position,

The system can be characterized in that the special solenoid valve (MV2k) is passive-closure-proof, in particular by the provision of an additional force device which comprises a permanent magnet (PM) and/or a second excitation coil (SP1b, SP2) and which is arranged to provide at least one restraining force (FPM, FEM2) acting on the valve actuator (7) or valve tappet (7a).

One aspect of the invention is that the special solenoid valve is passive-closure-proof, in particular by providing an additional force device which comprises a permanent magnet and/or a second excitation coil and which is arranged to provide at least one retaining force acting on the valve actuator or the valve tappet.

The special solenoid valve can therefore also be used as an isolating valve, for example as part of the second pressure supply unit (hereinafter also referred to as second brake module BM2), wherein the second brake module BM2 does not have to contain an isolating valve if there is only one hydraulic connection to the first brake module (FIG. 9, FIG. 10, FIG. 15) and is also referred to as brake module BM2 in the embodiments without an isolating valve. The passive-closure-proof properties also lead to a significant improvement in the system here. In general, other valves can also be used in accordance with the invention, which have corresponding passive-closure-proof properties. The system is preferably a 2-box system, in which the first pressure supply unit is part of a first box and the second pressure supply unit is part of a second box,

If a special solenoid valve is used that has the aforementioned permanent magnet and/or the second excitation coil, it can be designed similarly or identically as described above. The additional force device can also generate an additional restoring force in addition to the aforementioned restraining force.

With the advantageous use of a second pressure supply unit for pressure reduction to a low friction coefficient, even low-cost ABS/ESP brake systems can achieve a new level of control quality and certainly compete in terms of braking distance performance with innovative 1-box brake systems (DE102013222281A1, Brake Manual 5th edition, Chapter 20.3 “Integrated Brake System MK C1”).

Irrespective of the design of the second pressure supply unit, in one embodiment the first pressure supply unit can be equipped with a rotary pump with pressure build-up and pressure reduction according to the direction of rotation of the rotary pump, which creates a further degree of freedom for pressure reduction. Furthermore, in this embodiment, due to the lack of back pressure in the accumulator chamber, the pressure can be easily reduced during ABS operation with a low friction coefficient (“low-μ”). This results in a highly precise and cost-effective system.

In a (further) embodiment, the first pressure supply unit can be designed in such a way that a pressure reduction into a reservoir instead of into an accumulator chamber is provided. This is possible due to the high safety gain achieved by the special solenoid valve according to the invention, particularly when used as an inlet valve, and significantly improves the ABS control performance.

In one embodiment, a braking torque is built up together with electrical traction motors on one or more axles simultaneously via the electrical traction motors and the pressure of the first and/or second pressure supply unit. In this context, electrical brake force distribution (EBD) can be performed during pressure build-up by means of the first and/or second pressure supply unit in order to prevent the rear wheels from locking before the front wheels. If a wheel locking pressure is reached, the ABS control can start according to the invention and the braking torque of at least one traction motor is reduced very quickly. With electrical traction motors that are operated at high voltage (>400 V, in particular >700 V) and have braking torque gradients>10000 Nm/s, a corresponding procedure does not represent a safety risk and functions quickly enough for a safe braking torque reduction, optionally already in the first control cycle. According to the invention, this can be made possible by introducing the central vehicle dynamics control FDS, which synchronizes electrical traction motors™ and the pressure generator units and detects an ABS case very quickly by evaluating wheel speed sensors. For this purpose, the primary control unit can be communicatively connected to the wheel speed sensors in such a way that the corresponding sensor values can be read in directly. Thanks to the approach according to the invention, a TTL of 150 ms can be achieved in the automatic emergency brake with only the pressure generation via the pump of the first brake module BM1, wherein comparable values were previously only reserved for 1-box brake systems with powerful brushless motors.

Alternatively or additionally, a 6-piston pump or a more powerful brush motor can also be used in the first pressure supply unit according to the invention (in addition to the electrical traction motors), with which a shorter TTL time can be achieved. With this approach, good TTL times, possibly in the region of 150 ms, can also be achieved with less powerful electrical traction motors. According to the invention, the individual measures can be combined differently in a modular concept.

The pressure supply unit can be designed for both pressure build-up and pressure reduction. The first and second pressure supply units can each have a secondary control unit, each of which has at least one communication interface. These communication interfaces can be used to establish communication with the primary control unit. In particular, measurement signals and control setpoints can be exchanged. The special solenoid valve of the second pressure supply unit can be arranged in such a way that a valve seat of the special solenoid valve is (directly) connected to an input of the first pressure supply unit (valve connection variant III). Due to the arrangement of the special solenoid valve, the valve opening cross-section can be adjusted, in particular by means of PWM control or current control. In this case, this special arrangement also means that pressure can be throttled via the special solenoid valve from the first pressure supply unit and thus reduced with low noise. In this arrangement, the pressure is preferably built up via time control or volume measurement (see previous explanation on pressure control/pressure regulation via volume measurement).

In one embodiment, the primary control unit is designed to implement wheel brake-specific or brake circuit-specific pressure control by activating at least one of the special solenoid valves of the first pressure supply unit and/or the at least one second pressure supply unit.

In one embodiment, the primary control unit is designed to detect a wheel circuit failure by measuring the pressure when the special solenoid valves of the first pressure supply or an inlet valve is closed. A corresponding diagnostic procedure can include measuring whether the pressure in the system drops even though all relevant valves are closed. If this is the case, it can be assumed that there is a leak. Pressure can still be built up in the remaining brake circuits or other non-leaking wheel circuits by closing a special solenoid valve. For example, the second pressure supply unit can build up the pressure with a piston movement.

If there is no pressure increase that correlates with the piston movement, a leak can also be concluded in this case.

As already explained, the primary control can be designed to isolate a defective brake circuit by closing at least one of the isolating valves. In a preferred embodiment, it is therefore possible to isolate either wheel circuit-specific or brake circuit-specific disconnections in order to isolate defective brake circuits or wheel brake circuits and maintain the functionality of the rest of the system.

The primary control unit can be designed to implement an (axle-related) ABS by controlling at least one of the isolating valves and (alternating) pressure build-up and pressure reduction via the second pressure supply unit. Unlike conventional systems, the second pressure supply unit can therefore also be used to implement at least a (rudimentary) 1-channel ABS. This leads to additional redundancies.

In one embodiment, the primary control unit is designed to implement (automatic) emergency braking by actuating the traction motors and at least the first pressure supply unit in parallel. A corresponding control strategy can also be implemented with just one traction motor.

The primary control unit can be designed to implement an (automatic) emergency braking function (AEB) or a braking torque build-up, in particular a high braking torque (>3 m/s² vehicle deceleration) by controlling the electrical traction motor and electrohydraulic braking. When implementing emergency braking, the braking torques of electrical traction motors and the first pressure supply unit are generated additively up to a high deceleration (>5 m/s²), preferably up to the maximum deceleration (>8 m/s², in particular >9.5 m/s²). An ABS situation can be detected by evaluating wheel speed sensors during the emergency braking function, I.e. during highly dynamic pressure build-up. In this case, the primary control can reduce the braking torque of the electrical traction motor and/or the electrohydraulic brake (central) on one or more locking wheels or the braking torque of a vehicle axle.

In one embodiment, the first electromagnetic drive is redundantly provided with at least one first solenoid valve driver and one second solenoid valve driver, wherein the secondary control unit for controlling the at least one special solenoid valve is communicatively connected to the first solenoid valve driver and the primary control unit for controlling the at least one special solenoid valve is communicatively connected to the second solenoid valve driver. This means that the special solenoid valve can be activated by two separate control units, so that its actuation can continue to be ensured even if one of the control units fails. The communicative connection can be an electrical connection.

In one embodiment, the primary control unit is designed to set a brake pressure at least secondarily in at least one selection of the wheel brakes in a multiplex/PPC process, wherein the primary control unit sends a control signal to the second pressure supply unit in order to build up or reduce the pressure,

In one embodiment, a new FDS architecture is created with communicative interfaces Int-BM1, Int-BM2 between the central computer or primary control unit and the control unit of a brake module (BM1 or BM2) and, in the case of several brake modules (BM1 and BM2), a further interface Int_{2BM} between the control units of the two brake modules S-ECU1 and S-ECU2. The Int-2BM interface is based on the VDA360 guideline, which was defined for the interaction of an electric regenerative brake booster (e.g. i-booster product) and an ESP-hev brake system for recuperative braking, including an interface for valve actuation of the outlet valves of the ESP-hev system. In addition, at least one electrical traction motor (TM1, TM2, TM3) is integrated in the FDS. At least one further interface is provided between the central computer and the traction motor, preferably an IntTMᵢ interface between the M-ECU and the secondary control unit of the respective traction motor (S-ECU-TMi) or an interface between the M-ECU and the control unit of the respective axle of a vehicle (IntTM_{HA}, IntTM_{VA}), especially if the axle comprises several traction motors. This configuration is advantageous if, for example, a traction motor is provided for each wheel on the rear axle in order to accelerate or brake the wheel individually.

One or more of the communicative interfaces can be an electrical connection, a wireless connection or an optical connection, wherein two communication paths are preferably selected. A first communication path can be redundant, and a second communication path can be used to check the signals of the first communication path. In one embodiment, the 2 out of 3 principle is implemented with two different signal transmission types so that the requirements for SAE level 5 are met and errors in the transmission can be ruled out. The 2 out of 3 principle is mandatory for brake systems for SAE Level 4 with electric pedal or SAE Level 5 without pedal, as there is no longer a brake pedal available for the driver to reach through.

In addition, the primary control unit can also control the solenoid valve drivers of the Inlet valves of the first pressure supply unit. This means that only the second pressure supply unit and the special solenoid valves on the wheel brakes can be used for wheel-specific pressure control, in particular a 4-channel ABS or wheel-specific brake torque interventions for steering functions, regardless of the operating capability of the pressure generator, e.g. the pump, and the secondary control unit of the first pressure supply unit. In one embodiment, the solenoid valve drivers, in particular the special solenoid valves, are redundant in design.

In one embodiment, the secondary control unit of the first pressure supply unit is equipped with solenoid valve electronics that are electrically isolated from the main control board, which is supplied with its own voltage and can therefore be operated independently. In this way, a fully-fledged ABS can be realized even in the event of a complete failure of the first pressure supply unit.

Furthermore, the implementation of central vehicle dynamics control in a domain of a central computer with chassis control can be simplified by integrating steering actuator(s), e.g. electric power steering and electrical traction motor(s), Existing software architectures can essentially be retained and overarching additional functions that require the interaction of steering actuator(s) and electrical traction motor(s) can be easily implemented, e.g. in the primary control unit. In one embodiment, functions of the first pressure supply unit are transferred to the primary control unit, so that the first pressure supply unit is only designed as a pressure actuator,

As the central vehicle dynamics control system for a vehicle, the driving dynamics system FDS can comprise several of the components listed below:
a primary control unit (M-ECU) for detecting and/or generating steering commands and braking commands;
wherein at least one of the functions ABS, ESP, TCS, ACC, AEB, recuperative braking, steering in the primary control unit has redundant microcontrollers μC1, μC2, μC3;
at least one electrical traction motor TM1, TM2, TM3 for driving and braking wheels, one secondary control unit each (ECU-TM1, ECU-TM2, ECU-TM3) or vehicle axle control unit (ECU-VA, ECU-HA);
at least 1 brake module (BM1) with hydraulic connections for several wheel brakes;
a central vehicle model by means of which the steering and braking commands can be calculated taking into account the friction coefficient of the road surface, the vehicle speed and/or the dynamic weight distribution during braking;
wherein at least the wheel speed sensors and preferably other sensors (acceleration sensors and/or weight sensors) are read into the primary control unit for braking and steering.

The FDS driving dynamics system can be characterized in that the primary control unit (M-ECU) sends steering and braking commands for brake torque modulation (e.g. ABS, ESP, EBD) to several secondary control units in such a way that either
an electrical traction motor or a BM1 or BM2 brake module provides a basic braking torque and the braking torque modulation (e.g. ABS, ESP) is controlled via electrical traction motors
or the braking torque modulation is controlled jointly by at least one electrical traction motor and at least one brake module (BM1 or BM2)
or the braking torque modulation on the rear axle is controlled via electrical traction motors and the braking torque modulation on the front axle is controlled via at least one electrohydraulic brake module (BM1, BM2).

The FDS can be used to such advantage that the brake units are optimized depending on the braking situation (comfort braking, emergency braking), road conditions (braking on asphalt, snow, ice, u-jump, m-split) and availability of the brake modules with regard to maximizing recuperation and brake control performance in different driving situations. In addition, control via the FDS and regenerative braking via electrical traction motor(s) should reduce the costs of the brake callpers, even at high decelerations<5 m/s. Regenerative braking minimizes the thermal load on the friction brake and makes it possible to reduce the size of a disc brake on the front axle or use a drum brake on the rear axle.

During braking torque modulation, at least one brake module (BM1, BM2) and at least one electrical traction motor (TM1, TM2, TM3) are controlled simultaneously via the central primary control unit and the braking torque commands are distributed to at least one brake module and at least one electrical traction motor.

By designing the brake system with at least one brake module (BM1, BM2) and special solenoid valves with preferably direct control via a primary control unit, wheel-specific braking torque interventions can be carried out by means of control via the primary control unit. According to the invention, if one wheel circuit falls, the remaining wheel circuits can continue to be operated by closing a special valve of the failed wheel brake circuit. Furthermore, the TTL time can be minimized via the central control of at least one traction motor and at least one brake module.

The following functions particularly benefit from this embodiment:
Automatic emergency brake AEB with high dynamics (50-180 ms) through joint braking torque interventions via electrical traction motor and brake module
Wheel-specific brake torque interventions for steering assistance (Brake to Steer BtS) or drive dynamics (Brake to Torque Vectoring BtTV)
Vehicle stabilization (ESP function) at high yaw speeds
Wheel-specific or axle-specific regenerative braking.

According to the invention, the new functions and the improved reliability can be achieved by modifying the hydraulic structure and replacing fewer components on the basis of a 2-circuit ABS/ESP braking system. This creates a three-circuit or four-circuit braking system with significant safety advantages. The driving dynamics system FDS can also provide wheel-specific braking torque control via a pressure interface Int-BM1 with the primary control unit, wherein wheel-specific or axle-specific braking torque control via the pressure interface is easier to implement than with a standard ESP unit. The system according to the invention can also regulate the pressure in the individual wheel brakes more precisely and dynamically. By means of the system according to the invention, wheel-specific braking torque interventions can always be carried out on three-wheel brakes, which leads to significant advantages in vehicle stabilization functions and highly dynamic processes, such as AEB with electronic brake force distribution (EBD).

The driving dynamics system also meets the redundancy requirements of SAE level 3-5 autonomous driving (redundant brake boosting, redundant ABS and EBD function). The system can be operated with two pressure supply units (so-called 2-box brake system with one pressure supply unit each) in such a way that, in addition to the redundant ABS/ESP function, the control performance at low friction value low-μ is significantly improved by interaction of the ESP-X unit with an external pressure generator DV2, in particular as part of a pressure supply unit, compared to the prior art. The advantageous integration into a domain architecture of an electric vehicle with a central computer in the form of the primary control unit is also intended to improve the emergency braking function AEB by synchronized setpoint specification of braking torques to the control unit(s) of one or more electrical traction motors as well as setpoint specifications of braking torques. This can significantly reduce the TTL.

Since the braking torque of the electrical traction motors acts either only on one vehicle axle or with different braking torques on several vehicle axles, the brake force distribution (EBD) must also be controlled, i.e. the hydraulic braking torque must be distributed differently to the front and rear axles than in a standard EBD control system. The system according to the invention can prevent the rear axle wheels from locking before the front axle wheels, and the front axle wheels may only lock at a deceleration of 0.85 g. In the event of wheel locking, the ABS then intervenes, and the braking torque of the electrical traction motor must be taken into account in the ABS control.

One embodiment of the driving dynamics system according to the Invention can be characterized in that at least two, preferably four, inlet valves of the first pressure supply unit are replaced by special solenoid valves that are open without current. In contrast to the prior art, the passive-closure-proof special solenoid valve does not have a non-return valve that is arranged in a parallel hydraulic path to the inlet valve or is integrated in the inlet valve. As already explained in the problem definition according to the prior art, the non-return valve serves to ensure a safer brake pressure reduction from the wheel brakes even in the event of failure or partial failure of the brake system, e.g. the pressure supply unit. In the systems according to the invention, however, this can be dispensed with.

The aforementioned object is also solved by a switching valve. This switching valve can be used in particular in conjunction with the driving dynamics systems already described. This switching valve can be used on the one hand in the function of an inlet valve (of an ESP system) and on the other hand in the function of an isolating valve of a second pressure supply unit.

The switching valve can comprise:
a valve actuator or a valve tappet;
an armature that is connected to the valve actuator or the valve tappet;
an electromagnetic drive having at least one excitation coil for adjusting the valve tappet between an open valve position and a closed valve position along a longitudinal direction.

The switching valve can be characterized in that the armature comprises at least one permanent magnet. In one embodiment, this is arranged in such a way that the valve actuator or the valve tappet is held in the open valve position by means of the magnetic force generated by the permanent magnet. Preferably, this magnetic force also acts without energizing the electromagnetic drive. This enables the switching valve to achieve a particularly high resilience to passive closure, especially when high volume flows pass through the valve.

The switching valve described above, as well as the embodiments of the switching valve explained below, can be used as a special solenoid valve within the meaning of the present invention.

In one embodiment, at least one ring permanent magnet or a plurality of permanent magnets is provided in the armature. The ring magnet or the plurality of permanent magnets can have a pole orientation that is essentially perpendicular to the longitudinal direction.

In one embodiment, the ring permanent magnet or the plurality of permanent magnets are embedded axially and radially in a material with ferromagnetic conductive properties.

In one embodiment, the permanent magnets (PM) and/or the adjacent ferromagnetic flux guide pieces are arranged and dimensioned in such a way that, when the electromagnetic actuator is de-energized, the magnetic force moves the valve tappet from the closed valve position to the open valve position. It is therefore a de-energized open valve that opens automatically in the event of a power failure. This has particular advantages, especially in conjunction with the driving dynamics system described above.

The electromagnetic drive can comprise the first excitation coil and at least one second excitation coil. There are therefore redundant excitation coils, which are preferably connected to separately designed solenoid valve drivers. This generally increases the reliability of the valve. Furthermore, the valve can be connected separately to different control units, e.g. one of the secondary control units and the primary control unit. This means that one of the control units can take control of the valve if the other control unit fails,

In one embodiment, an H-bridge with four switches, in particular power semiconductors, is provided, by means of which an electromagnetic field with different polarization can be generated, so that when the excitation coil is energized, the valve can be actively closed and opened depending on the wiring of the H-bridge and the resulting current direction through the excitation coil and can be operated independently of the flow direction by means of current control with variable cross-sections both during pressure build-up and pressure reduction. The H-bridge makes it possible to reverse the electrical magnetic field through at least one excitation coil and also to adjust the magnetic field strength. This allows the force on the armature (In the effective direction) and the amplitude to be regulated.

In an (alternative) embodiment, the switching valve advantageously provides a new and at the same time cost-effective design according to the invention with a first soft iron magnetic circuit EM1 and a second magnetic circuit EM2 generated via a permanent magnet, wherein in one embodiment the forces of the two magnetic circuits EM1 and EM2 act on the armature of a ball seat switching valve,

Some of the switching valves according to the invention can be manufactured inexpensively by using most of the components of a standard solenoid valve (e.g. armature diameter and magnetic circuit with coils) and modifying only the end part (head part) of the valve.

The head part is equipped with a permanent magnetic circuit, which means that the special solenoid valve combines a soft iron magnetic circuit (EM1) and a second magnetic circuit (EM2) generated by a simple permanent magnet in one valve. This embodiment has the great advantage that existing production facilities can be used for manufacturing. Inlet valves, preferably with unchanged diameters and the same interfaces to the hydraulic block (HCU), can simply be replaced by the special solenoid valves using the typical press-fit assembly technique, i.e. the special solenoid valves can simply be inserted into an unchanged hydraulic block. In addition, the ECU (=secondary control unit), which is attached to a hydraulic block and carries the excitation coils of the solenoid valves, does not need to be modified or only needs to be modified slightly.

In general, the Brake module BM1 with special solenoid valves (ESP-X) described above can be used in a variety of configurations (A-E) as follows:
A) Configuration A: Brake module BM1 (e.g. as ESP-X) hydraulically connected to a vacuum brake booster;
B) Configuration B: Brake module BM1 hydraulically connected to an electric brake booster, e.g. as described in DE112009004636B4;
C) Configuration C: Brake module BM1 hydraulically connected to electro-hydraulic brake booster with pedal feel simulator;
D) Configuration D: Brake module BM1 hydraulically connected to a second brake module BM2 and controlled via a primary control unit and an E-brake pedal;
E) Configuration E: Brake module BM1 as an independent pressure control unit, controlled via a primary control unit, e.g. as an axle module for actuating two-wheel brakes, or central hydraulics for actuating four wheel brakes.

The use of the passive-closure-proof special valve (wheel brake circuits can be disconnected by closing the special solenoid valve) enables all configurations A-E:
diagnosis of the leakage by, for example, measuring the pressure Increase or volume flow during pressure build-up by a pressure supply unit when the valve is closed;
diagnosis of the wheel brake circuit failure by measuring the pressure increase or volume flow when the valve is open and comparing it with the typical pressure-volume characteristic curve of the wheel circuit previously measured and stored in the memory;
decision on continued operation of the wheel brake circuit even with low leakage;
decision to disconnect the brake circuit by permanently closing the valve connected to a failed wheel brake circuit and continue operation with three-wheel circuits;
pressure reduction selectively via outlet valves or the special solenoid valve;
holding wheel brake pressures at low brake pressures in other wheel brakes.

Furthermore, if, for example, an excitation coll or a solenoid valve driver of a normally closed outlet valve fails, the pressure can alternatively be reduced via an inlet valve, which increases the availability of the FDS driving dynamics system.

As the special solenoid valve is of particular importance for function and safety, it is advantageous if this valve has redundant coils and solenoid valve drivers in addition to the passive-closure-proof design. In the case of normally closed outlet valves, this redundancy can be dispensed with for cost reasons, as the pressure can still be reduced via the special solenoid valve if an outlet valve fails. This ensures a redundant pressure build-up. This greatly reduces the probability of failure of a wheel brake circuit and the driving dynamics system can be operated with high reliability with all wheel brake circuit channels. Redundancy is particularly important in the case of wheel-specific brake torque control, especially in the case of central vehicle dynamics control via a primary control unit, e.g. for the BtS and BtTV functions.

In one embodiment of the invention, the known pressure control methods can remain unchanged and the pressure build-up takes place via pre-pressure control and operation of the Inlet valves with variable valve opening cross-section, The solenoid valves are operated by current control or current control as proportional valves (simplified in technical circles as PWM operation of the inlet valves).

In a (further) embodiment, the new degrees of freedom in the control strategy can be used in pressure control. This enables functional improvements in ABS operation as well as new functions, e.g. wheel-specific braking torque intervention via the pressure interface with the central computer. The new functions of the central vehicle dynamics control are, in particular, wheel-specific braking torque control for torque vectoring (BtTV), braking torque intervention for yaw rate control of the ESP function or steering function (BtS) and/or axle-specific or wheel-specific regenerative braking.

In one embodiment (valve connection variant I), the valve seat of the inlet valves, in particular the special solenoid valve, is connected to the brake circuit(s) and the armature chamber is connected to the wheel brake. Pressure control method A (=standard pressure setting mode or EV_{PWM}/AV_{Δt}-pressure control method) is used here, namely the conventional pressure control method with PWM control of the inlet valves during pressure build-up and time control of outlet valves during pressure reduction (Brake Manual FIG. 20.12. a).

Alternatively, the pressure control method B (multiplex/PPC method, hereinafter also referred to as “special pressure setting mode I”) can also be used for connection variant I due to the passive-closure-proof inlet valves. As illustrated in the Brake Manual 5th edition, Chapter 20.4 “Integrated Brake System IBS”-FIG. 20.13, the multiplex/PPC method has great advantages in ABS control at low road friction values, because the pressure reduction gradient is not limited by the back pressure of an accumulator chamber due to pressure reduction via a piston-cylinder unit and therefore lower wheel speed drops of the locking wheel can be realized. The passive-closure-proof inlet valve, in particular in the form of the special solenoid valve, is used in the same way as the switching valve shown in the Brake Manual FIG. 20.12. b. Another pressure supply unit, for example the second pressure supply unit, is advantageously used as the pressure source and pressure sink. The second pressure supply unit can comprise a piston-cylinder unit or rotary pump, wherein the piston of the piston-cylinder unit is advanced during pressure build-up and pressure reduction is retracted or the direction of rotation of the pump motor of the rotary pump is changed during pressure build-up (p_{auf}) and pressure reduction (p_{ab}).

For pressure control according to pressure control method B and the use of a piston-cylinder unit, the PPC method (“Piston Pressure Control”) known in specialist circles can be used, wherein the pressure can be built up and reduced highly dynamically by using the sensor signals current, piston position and pressure volume characteristic curve. This approach can also be used to precisely control the pressure curve over time. The inlet valve can be operated open during the pressure change and the pressure curve is preferably controlled exclusively by the volume control via the piston-cylinder unit (control via controller cascade with piston travel, piston speed and current of the electric motor) or controlled (current-proportional pressure control), During pressure build-up, the inlet valve can either be time-controlled or throttled in sequence using the multiplex/PPC method (pressure control method B: p_{auf}/P_{ab}: multiplex/PPC method) with PWM control (p_{auf}: EV_{PWM}; P_{ab} (1): EV_{Δt}, P_{ab} (2): AV_{Δt} pressure control method). This means that the driving dynamics system according to the invention can be used to simultaneously set different brake pressures on different wheel brakes with high precision.

In one embodiment, it is possible to switch between pressure control method A (standard pressure setting mode) and pressure control method B (special pressure setting mode I) during operation. It is preferable to switch between the pressure control methods in such a way that pressure control method A is used for ABS pressure control on asphalt (high-μ) or in the event of a friction value jump (μ-jump), wherein high-pressure changes must be achieved simultaneously on several wheel brakes. The pressure control method B is preferably used with low friction values, e.g. snow/ice (low-μ). Preferably, the primary control unit is designed to detect the different conditions. In one embodiment, one brake circuit of the driving dynamics system can be operated with pressure control method A and the second brake circuit with pressure control method B, provided that the primary control unit is configured accordingly.

In another embodiment (valve connection variant II), the special solenoid valve with the valve seat is connected to the wheel brake, whereby the pressure can be reduced in a throttled manner with a variable valve opening cross-section. In this embodiment, the pressure can be built up using the second pressure supply unit, preferably by moving the piston and by time control instead of PWM operation using a multiplex/PPC method, either simultaneously or sequentially. In this embodiment, the control/regulation strategy of the first pressure supply unit or the primary control unit is preferably adapted so that the second pressure supply unit is used as a controllable or adjustable pressure sink and pressure source during pressure reduction. The differential pressure to the wheel brake pressure can be detected by determining the piston position and adjusted accordingly. With this valve connection variant II, one or more outlet valves can also be dispensed with. For example, four special solenoid valves can be used as de-energized open inlet valves and two de-energized closed outlet valves on the front axle. Outlet valves on the rear axle are then not required. Such a system has high dynamics and low noise levels.

In valve connection variant II, a third pressure control method C (μ_{auf}) EV_{Δt} P_{ab} (1): EV_{PWM}, P_{ab} (2): AV_{Δt} pressure control method) can be used in accordance with the invention, in which the pressure is reduced via a variable valve cross-section control of the inlet valves. In contrast to the valve connection variant I, the pressure can be reduced simultaneously and quietly via several inlet valves. This is particularly advantageous for low-noise control operation for electric vehicles. In one embodiment, the pressure is built up using pressure control method B (multiplex/PPC pressure control) or pressure control method C.

This results in embodiments with different pressure control methods, which are summarized in the following table.

| | | |
|---|---|---|
| | | With second pressure |
| | | supply unit/brake |
| Valve connection | | module BM2 |
| variant I | | (Special pressure |
| (Standard pressure | | setting mode I = |
| setting mode = Pressure | Valve connection | pressure control |
| control method A) | variant II | method B) |

Pressure build-up p_{auf}

| | | | |
|---|---|---|---|
| p_{auf} (EV) | Pressure control with | Time control of the | Multiplex/PPC method |
| | variable valve cross- | solenoid valves | |
| | sections | | |
| p_{auf} (EV), red. | Pressure control with | Time control of the | Multiplex/PPC method |
| solenoid | variable valve cross- | solenoid valves | |
| coil/driver | sections | | |

Pressure reduction p_{ab}

| | | | |
|---|---|---|---|
| p_{ab} (AV) | Time control of the | Time control of the | Multiplex/PPC method |
| | solenoid valves | solenoid valves | |
| p_{ab} (EV) | Time control of the | Pressure control with | Multiplex/PPC method |
| | solenoid valves | variable valve cross- | |
| | | sections | |

According to the invention, it is possible to implement the pressure build-up (μ_{auf}) and the pressure reduction (P_{ab}) without redundancies. As an example, the pressure build-up can be implemented exclusively via inlet valves (EV) (see table row with “p_{auf} (EV)” in the first column) and the pressure reduction exclusively via outlet valves AV (see table row with “p_{ab} (AV)” in the first column).

Preferably, however, redundancies are provided as shown in the table, wherein a redundant solenoid coil and a redundant driver for the inlet valve are preferably provided as redundancy for the pressure build-up (cf. table row with “p_{auf} (EV), red. solenoid coil/driver” in the first column).

In some embodiments, redundancy for pressure reduction can be ensured by reducing the pressure via outlet valves (cf. table row with “pat (AV)” in the first column) or inlet valves (see table row with “P_{ab} (EV)” in the first column). Without these redundancies in the hardware and software, a pressure reduction via the outlet valve, for example, cannot take place if a solenoid coil of an outlet valve fails, because the valve is closed when there is no current and thus blocks the pressure reduction. This can lead to a permanent blockage of the associated wheel brake,

The driving dynamics system according to the invention has the general advantage that wheel-specific braking torque interventions and novel control strategies for recuperative braking can be provided more easily and efficiently because, in contrast to the prior art, the pressure in a selected wheel brake can be maintained with the special solenoid valve, at least in some embodiments, while the braking pressure in other wheel brakes is varied.

If the pressure is reduced via the special solenoid valve, In contrast to conventional methods with pressure reduction via outlet valves, the pump of the first pressure supply unit must be controlled in order to return the pressure. This applies in particular to embodiments according to the configurations (C) and (D) described above. However, in the case of ABS operation with a low friction coefficient (“low-u”), the method is also possible in configuration (B). Configuration (E) also offers corresponding advantages if a controllable or adjustable pressure sink, e.g. in the form of a rotary pump, is provided in an embodiment of the first pressure supply unit, which can reduce pressure by reversing the direction of rotation.

The object mentioned at the beginning is further solved by a method. In particular, the object is solved by a method for adjusting a brake pressure in at least one wheel brake of a brake system, which comprises the following steps of:
determining that pressure is to be released from at least one of the wheel brakes, namely a target wheel brake;
selecting a pressure reduction mode from a first pressure reduction mode and a second pressure reduction mode;
when the first pressure reduction mode is selected, opening at least one of the outlet valves associated with the target wheel brake to implement pressure reduction;
when the second pressure reduction mode is selected, keeping the outlet valve associated with the target wheel brake closed and opening at least one of the inlet valves associated with the target wheel brake and generating a differential pressure in an (external), preferably second, pressure supply unit in order to implement the pressure reduction from the target wheel brake via the inlet valve.

One aspect of the invention is therefore that different modes can be selected for optimum pressure reduction, particularly depending on the situation. At least in one mode, the pressure is reduced via a (special) inlet valve. On the one hand, this enables improved availability (e.g. operation in the event of partial valve failure) and, on the other hand, pressure reduction with lower pressure oscillations and thus low noise, namely
the pressure can also be applied if an outlet valve fails (outlet valve is closed when de-energized),
the pressure reduction can be regulated or controlled via an external pressure source in the pressure gradient and/or pressure gradient curve,
the pressure reduction can be carried out quietly via the special valves if valve connection variant II is selected.

In the context of the invention, keeping a valve closed, in particular an outlet valve, does not necessarily require this valve to be actuated in any way. Rather, a normally closed valve, as is often used as an outlet valve, can be kept closed according to the invention by not applying any current and not outputting any kind of activation signal,

Alternatively, the object is solved by a method for carrying out ABS braking in a vehicle, wherein the method comprises:
determining a required pressure reduction gradient for at least one-wheel brake;
using the required pressure reduction gradient to select one pressure setting mode from a plurality of pressure setting modes, wherein the pressure setting modes include at least a first and a second pressure setting mode;
if the first pressure setting mode is selected, pressure reduction of at least one wheel brake via at least one outlet valve using a timer;
if the second pressure setting mode is selected, pressure reduction of a wheel brake, preferably with the outlet valve closed, exclusively via a further solenoid valve, wherein the pressure from the wheel brake is transferred via the further valve into a controllable/regulatable pressure sink.

The mode used for pressure reduction is therefore selected depending on the required pressure gradient. Additionally, or alternatively, the amount of fluid to be depressurized or the pressure difference can also be taken into account when making the selection.

The first pressure setting mode can be a standard pressure setting mode, as already explained. The second pressure setting mode can be the special pressure setting mode I.

In one embodiment, the plurality of pressure setting modes comprises a third pressure setting mode, for example special pressure setting mode II. When the third pressure setting mode is selected, pressure reduction of at least one wheel brake can be performed at least temporarily in parallel via at least one outlet valve associated with the wheel brake and at least one further solenoid valve associated with the wheel brake. The further solenoid valve can be a special solenoid valve, as described in connection with the various embodiments. The pressure can be reduced quickly and efficiently by using an inlet valve and an outlet valve for pressure reduction at least temporarily at the same time.

In one embodiment, a low pressure is set in the pressure sink, in particular <than 5 bar, preferably <than 3 bar, when the second pressure setting mode is selected.

The object mentioned at the beginning is also solved by a primary control unit having Instructions for implementing at least one of the methods described.

Furthermore, the object is solved by a vehicle or driving dynamics system having one of the described primary control units, in particular the last described primary control units.

Further advantageous embodiments are shown in the subclaims.

The invention is described below by means of several embodiment examples, which are explained in more detail with the aid of figures, wherein these show as follows:

FIG. 1: shows an ESP hydraulic circuit diagram according to the prior art;

FIG. 2a: shows an FDS system architecture with primary control unit and several secondary control units for traction motors and two brake modules BM1, BM2;

FIG. 2b: shows an exemplary embodiment example of the brake modules according to FIG. 2a with special solenoid valves as isolating valves;

FIG. 2c: shows a valve connection variant for connecting the special solenoid valves as isolating valves according to FIG. 2b in the second brake module;

FIG. 3a: shows a schematic representation of a first brake module BM1, in which two inlet valves of a brake circuit are equipped with passive-closure-proof special solenoid valves (with 3-channel brake torque modulation function);

FIG. 3b: shows a schematic representation of a first brake module with a connected second brake module, wherein the four inlet valves of the two brake circuits in the first brake module are equipped with passive-closure-proof special solenoid valves (with 4-channel brake torque modulation function);

FIG. 4a: shows a schematic representation of a special solenoid valve with permanent magnet and return spring;

FIG. 4b: shows a displacement-force diagram to illustrate the forces acting on the valve actuator of the special solenoid valve shown in FIG. 4a;

FIG. 5a: shows a schematic representation of a special solenoid valve with a permanent magnet integrated in the valve armature, wherein the armature can be actuated by an electromagnetic field with different polarization;

FIG. 5b: shows a displacement-force diagram to illustrate the forces acting on the valve actuator of the special solenoid valve shown in FIG. 4a as a function of the applied current;

FIG. 6: shows an H-bridge as driver for the special solenoid valve according to FIG. 5a for the generation of an electromagnetic field with different polarization;

FIG. 7a: shows a schematic representation of a modification of the embodiment example shown in FIG. 3b without USV valves (with 4-channel brake torque modulation function);

FIG. 7b: shows a schematic representation of a modification of the embodiment example shown in FIG. 3b without USV valves and with non-return valves as a replacement for the HSV valves (with 4-channel brake torque modulation function);

FIG. 8a: shows a schematic representation of a first brake module for two-wheel brakes with a single piston pump, in which the two inlet valves are designed as a special solenoid valve (pressure reduction into an accumulator chamber);

FIG. 8b: shows a schematic representation of a modification of the embodiment example according to FIG. 8a with multi-piston pump (pressure reduction into a reservoir);

FIG. 8c: shows a schematic representation of a modification of the embodiment example according to FIG. 8a with a rotary pump instead of the piston pump (pressure reduction via outlet valves into the reservoir and/or special solenoid valves with a controlled/regulated rotary pump as a pressure sink);

FIG. 9: shows a schematic representation of a modification of the embodiment example shown in FIG. 7b with only one hydraulic connection for the second brake module;

FIG. 10: shows a schematic representation of a modification of the embodiment example shown in FIG. 9 without accumulator chambers;

FIG. 11: shows a schematic representation for visualizing a control strategy of an inlet valve;

FIG. 12: shows a schematic representation for visualizing a control strategy of an outlet valve;

FIG. 13a: shows a schematic representation of the use of the first brake module from FIG. 3a in conjunction with an electrically driven piston-cylinder unit as a second brake module, wherein a pressure reduction from two-wheel brakes is visualized;

FIG. 13b: shows a schematic representation of the embodiment example according to FIG. 13a, wherein a pressure reduction in two-wheel brakes is visualized;

FIG. 14: shows a schematic representation of the use of the first brake module from FIG. 3b in conjunction with an electrically driven piston-cylinder unit as the second brake module, with a pressure reduction being visualized;

FIG. 15: shows a schematic representation of the use of the first brake module from FIG. 3b in conjunction with a centrifugal pump as the second brake module, wherein a pressure reduction is visualized.

### FIGURE DESCRIPTION

FIG. 1 shows the hydraulic circuit diagram of a first brake module BM1, which is designed as a standard ESP unit. The first brake module BM1 assumes the function of the first pressure supply unit. It comprises:
four time-controlled outlet valves AV1-AV4, each of which is assigned to a wheel brake RB1-RB4;
four PWM-controlled inlet valves EV1-EV4, each of which is assigned to a wheel brake RB1-RB4;
four non-return valves, each of which is arranged parallel to one of the inlet valves EV1-EV4 and is therefore also assigned to a wheel brake RB1-RB4. The non-return valves are arranged in such a way that they close when pressure builds up in the wheel brakes RB1-RB4 and open when the pressure drops, depending on the pressure conditions. Furthermore, the valves HSV1, HSV2, which enable brake fluid to be supplied via the pumps P, which are driven by the motor M, when the valves USV1, USV2 are closed, thus allowing the pressure to build up. Ultimately, the pumps P and the motor M form a two-piston pump (first pressure generator DV1) with one piston each for a first brake circuit BK1 and a second brake circuit BK2. Accumulator chambers Spk allow brake fluid to be absorbed via the outlet valves AV1-AV4 during pressure reduction. The arrows illustrate the possible flow directions of the brake fluid during pressure build-up and pressure reduction.

The first brake module BM1 shown in FIG. 1 provides an ESP and an ABS function. This ESP function is sufficiently well known and described in the literature; twelve solenoid valves are required for the function. Only the inlet valves EV1-EV4 and outlet valves AV1-AV4, I.e. eight solenoid valves, are required for the ABS function. The first brake module BM1 has the two brake circuits BK1, BK2, which are connected to a second pressure supply unit via two connection points. This can be one of the following:
I. Prior art vacuum brake booster
II. Electric follow-up brake booster and brake pedal
III. Brake booster with pedal feel simulator and brake pedal
IV. Second pressure generator DV2 with valves.

The first pressure supply unit of FIG. 1a has a pressure sensor p/u, which is arranged to detect the pressure in a brake circuit BK1.

The various functions of modern driving dynamics systems are shown in the following table.

| Functions for Gen9 | SW | Function Name |
|---|---|---|
| Brake & Boost Assist | BDW-V | Brake Disc Wiping - Value |
| Functions | BDW-P | Brake Disc Wiping - Performance |
| | EBP-V | Electronic Brake Prefill - Value |
| | EBP-P | Electronic Brake Prefill - Performance |
| | HBA | Hydraulic Brake Assist |
| | HBB | Hydraulic Brake Boost (incl. HBC) |
| | HBC | Hydraulic Boost failure Compensation |
| | HFC | Hydraulic Fading Compensation |
| | HRB | Hydraulic Rear wheel Boost |
| Special Stability Support | EUC | Enhanced Understeering Control |
| | LAC | Load Adaptive Control |
| | RMI | Roll Movement Intervention |
| | ROM | Roll Over Mitigation |
| | TSM-S | Trailer Sway Mitigation - Sym |
| | TSM-A | Trailer Sway Mitigation - Asym |
| Special Torque Support | ORD-M | Off Road detection - moderate (to be checked: HU & |
| | | ECU load, NVH, brake system . . .) |
| | ORD-F | Off Road detection - full (to be checked: HU & ECU |
| | | load, NVH, brake system . . .) |
| | ORD-X | Off Road detection - extended (to be checked: HU & |
| | | ECU load, NVH, brake system . . .) |
| Driver Assist Velocity & | MSA | Motor Start/Stop support |
| Standstill Support/Service | CDD-B | Controlled Deceleration for DAS: min speed 30 km/h |
| Functions (LDM) | | (Service for ACC) |
| | CDD-P | Only customer specific: Controlled Deceleration for |
| | | DAS: Stop&Go with SSM (Service for ACC) |
| | CDD-S | Controlled Deceleration for DAS: Stop&Go w/o SSM |
| | | (Service for |
| Driver Assist Velocity & | HHC-V | Hill Hold Control value with ax Sensor |
| Standstill | HHC-S | Hill Hold Control with ax Sensor |
| | HDC-V | Hill Descent Control (w. MV09SC) |
| | HDC-P | Hill Descent Control (w. MV09SCC) |
| | CDP | Controlled Deceleration for PB |
| | AVH | Automatic Vehicle Hold |
| | CCL | Cruise Control Speed Limiter |
| | CCB | Cruise Control Basic, vx = const, incl, active braking) |
| | CCS | Cruise Control Basic, vx switchable, active braking |
| | | incl. |
| | CCT | Cruise Control Touch Activated former TAD Only in |
| | | combination with LTM |
| VDM - Dynamic Steering | DST- | DST - Oversteering Function |
| Torque (DST) | OSF | |
| | DST- | DST - split-μ Braking Function |
| | MSB | |
| | DST- | DST - split-μ Acceleration Function |
| | MSA | |
| | | DST - Understeering |
| | | DST - Comfort Functions |
| VDM - Dynamic Steering | DSA- | DSA - Oversteering Function (neu: lift off) |
| Angle (DSA) | OSF | |
| | DSA- | DSA - split-μ braking |
| | MSB | |
| | AFS | Active Front Steering |
| VDM - Dynamic Wheel | DWT-B | DWT-B - Dynamic Wheel Torque Distribution by |
| Torque (DWT) | | Brake - Agility - Rollout for different H |
| | DWT-D | DWT-D - Dynamic Wheel Torque Control by |
| | | Differential |
| VMM - Dynamic Damper | DDF- | DDF - Oversteering |
| Force (DDF) | OSF | |
| CAPS (supporting functions) | ABP | Automatic Brake Prefill |
| | AWB | Automatic Warning Brake |
| | ABA | Adaptive (Hydraulic) Brake Assist |
| | AEB | Automatic Emergency Brake |
| CAPS - Longitudinal Safety | | CAPS - Extended Brake Assist (XBA) |
| Systems | | CAPS - Predictive Brake Assist |
| | | CAPS - Predictive Collision Warning (VW) |
| | | CAPS - Predictive Emergency Braking (PEB) |
| | | CAPS - Dense Traffic Assist (DTA) |
| CAPS - Secondary Collision | SCM | CAPS - Secondary Collision Mitigation (SCM) - Details |
| Mitigation | | tbd for each project! |
| CAPS - Advanced Occupant | | CAPS - PREFIRE^{ESP} (Activation of reversible belt |
| Safety | | tensioner). RoSE Interface req. |
| | | CAPS - Early Pole Crash Detection (EPCD), RoSE Interface |
| | | req. |
| | | CAPS - PRESET (Optimized restraint system activation). |
| | | RoSE Interface req. |
| Monitoring & Information | TPM-C | Tire Pressure Monitoring - Circumference method |
| | TPM-F | Tire Pressure Monitoring - Frequency method |
| | | (different versions from 2 suppliers) |

FIG. 2a shows the architecture of a driving dynamics system FDS according to the invention. The driving dynamics system has a first and a second traction motor TM1, TM2 on a rear axle HA of the vehicle and a third traction motor TM3 on a front axle VA. The system can have a brake module BM1 and optionally further brake modules, for example a second electrohydraulic brake module BM2. An essential element of the driving dynamics system is the primary control unit M-ECU chassis domain, M-ECU for short, which controls the braking torques of the traction motors TM1, TM2, TM3 and the brake modules BM1, BM2 for at least one of the following functions:
A) Emergency brake AEB with simultaneous electronic brake force distribution (EBD)
B) Axle-specific or wheel-specific regenerative braking
C) Brake operation via electric motor in the event of a brake module failure
D) Wheel-specific brake torque interventions for steering assistance or vehicle stabilization

The primary control unit M-ECU sends setpoint values to the various units, wherein the setpoint values include in particular braking setpoint torques or braking setpoint pressures. For certain functions, setpoint signals for pressure control or pressure regulation, e.g. control signals for solenoid valves and/or pre-pressures for the second brake module BM2 with a second pressure generator DV2 for pressure build-up or pressure reduction can be specified.

In one embodiment example, the primary control unit M-ECU has an interface to the control unit M-ECU_{AD} or the domain of autonomous driving and evaluates further information that is helpful for effective and predictive control. This includes, for example, camera information about the road conditions (snow, ice, rain) or information about the surroundings (distances to pedestrians and/or other vehicles).

FIG. 2b shows a so-called 2-box brake system, comprising a first and a second brake module BM1, BM2. The first brake module BM1 has a similar structure to the first brake module in FIG. 1a and has the range of functions outlined above. The second brake module BM2 has a piston-cylinder unit (also known as a plunger) driven by a spindle drive. The piston-cylinder unit forms a second pressure generator DV2. Two isolating valves TV1, TV2 are provided as part of the second brake module BM2, which can separate the brake circuits BK1, BK2 from the second pressure generator DV2 and which make it possible to implement core functions:
Brake booster;
Automatic emergency brake AEB;
Electronic brake force distribution EBD;
2-channel ABS function in multiplex/PPC mode.

In one embodiment example of the Invention, redundancy functions can be provided to fulfill the requirements for level 4 and 5 autonomous driving.

Control units, hereinafter referred to as secondary control units S-ECU1, S-ECU2a, S-ECU2b, are provided in both brake modules BM1, BM2, which communicate with each other and preferably have interface functions Intzem, (e.g. according to the VDA360 interface definition). Due to the communication possibilities between the brake modules BM1, BM2 and the (higher-level) control function of the primary control unit M-ECU), the components can interact in order to implement certain functions, e.g. a blending in which both the pressure generator of the second brake module builds up and reduces pressure while valves, e.g. the wheel inlet valves EV1-EV4 and wheel outlet valves AV1-AV4, are actuated in the first brake module at the same time.

The connection of the brake modules BM1 and BM2 to the primary control unit M-ECU via an interface IntBM1 and IntBM2 makes it possible to implement additional functions such as ABS, ESP, AEB, ACC and new domain functions such as torque vectoring (BtTV), steering intervention by braking (BtS) and recuperation management for the electrical traction motors TM1, TM2 and TM3. In this context, the brake modules BM1, BM2 can act as slaves, Le. pure pressure controllers, and implement specified setpoint values, e.g. pressure or braking torque setpoint values.

In at least one operating mode, the interface (primary) is used for synchronized actuation of both brake modules BM1, BM2 by the primary control unit M-ECU, e.g. the piston of the second pressure generator DV2 of the second brake module BM2 is moved while one or more solenoid valves of the first brake module BM1 are switched at the same time. Equipping the brake modules each with a separate interface enables the brake modules BM1, BM2 to be interchanged as required, i.e. the brake modules BM1, BM2 can be obtained from different suppliers.

Alternatively, only one interface IntBM1 or IntBM2 can be provided, which is communicatively connected to the primary control unit M-ECU. In this case, communication with the other unit takes place via a standardized interface Int2BM. In the embodiment example, wheel speed sensors vR1, vR2, vR3, vR4 are read redundantly by at least two control units, for example one of the secondary control units S-ECU1, S-ECU2a, S-ECU2b and the primary control unit M-ECU, so that the wheel speed signals can always be transmitted via the interfaces IntBM1, IntBM2, Int2BM.

In the embodiment example shown, the second brake module BM2 is hydraulically connected to a reservoir VB via a non-return valve RV_{NF} (alternatively, a solenoid valve can also be used instead of a non-return valve RV_{NF}) and preferably has two three-phase connections (2×3) to meet the requirements for autonomous driving of stages 4 and 5, wherein three phases are each controlled by a secondary control unit S-ECU2a, S-ECU2b, wherein current sensors i/u and motor angle sensors a/u are provided, which are preferably also designed redundantly and are used for high-precision PPC pressure control or pressure regulation via piston position or current. The redundant design of some components of the second brake module BM2 can increase availability and create a third fallback level for SAE level 5, analogous to the design of steer-by-wire (two steering actuators, wherein one steering actuator is equipped with 2×3 phase motor connections and partially redundant electronics), e.g. in the event of failure of the pump motor and partial failure of the motor (winding of the motor, power output stage on the ECU2a or ECU2b of the second brake module BM2), braking torque generation and braking torque control with approx. 50% of the motor torque is still possible. A pressure sensor p/u is preferably provided at the output of the pressure supply of the second brake module BM2, which is primarily used for calibration purposes. However, pressure regulation or pressure control can also be carried out without this pressure sensor if the relationship between BM2 braking torque and current or piston position is established in another way. This also enables further redundancy.

In the embodiment example shown in FIG. 2a, two special solenoid valves MV2k are used as (circuit) isolating valves TV1, TV2 in the second brake module BM2. The special solenoid valves MV2k are particularly passive-closure-proof and are designed in such a way that they can be used to both build up and release pressure with high flow rates Q. Preferably, they are suitable for implementing the pressure change for ABS operation in the multiplex/PPC method in a highly dynamic manner (I.e. with pressure gradients>1000 bar/see, preferably >2000 bar/sec). The special solenoid valves are designed according to the system specification, i.e. maximum brake pressures and maximum volume flows in a passive-closure-proof manner.

In one embodiment, special solenoid valves MV2k with a first soft iron magnetic circuit EM1 and second magnetic circuit EM2 as shown in FIG. 4 or special solenoid valves MV2k with a magnetic circuit EM1 and a permanent magnet PM in the armature of the valve as shown in FIG. 5a are used. When using a special solenoid valve MV2k with a permanent magnet PM embedded in the armature, an H-bridge is preferably used for current control, as explained in more detail with reference to FIG. 6. The special solenoid valve MV2k can then be operated in a current-controlled manner with a variable valve cross-section both during pressure build-up and pressure reduction. This enables particularly low-noise and high-precision pressure control during pressure build-up and pressure reduction, In the latter embodiment, a magnetic circuit EM1 and an excitation coil SP1 can be used to generate a magnetic force at different levels in both directions of movement. An advantageous positioning of the permanent magnet PM results in a restoring force even in the de-energized state, so that a return spring RF can be dispensed with. In accordance with the invention, however, at least one return spring RF can also be provided in addition to the permanent magnet PM, as shown, for example, in FIG. 4.

As an alternative to the valves shown in FIGS. 4 and 6, standard valves with a magnetic circuit EM1 without a permanent magnet, cf. the prior art in 1-box brake systems (DE102013222281A1), FIG. 1 reference signs 26a and 26b, can also be used as special solenoid valves. According to the invention, these valves are designed according to the pressure differences and pressure change rates of the implemented functions, in particular the AEB function and ABS function. Depending on the function, a stronger solenoid circuit with a larger armature and/or stronger return springs can be used.

The first brake module BM1 functions independently with standard pressure setting mode (pressure control method A), whereas the brake module BM2 is operated with pressure control method B. Furthermore, according to the invention, it is possible to switch between a standard pressure setting mode and a special pressure setting mode I with pressure reduction via a special solenoid valve and use of the brake module BM2 as a pressure sink with a pressure<5 bar, in particular <3 bar, if ABS operation takes place at very low road friction values (low-μ, μ-split).

This switchover option also exists in the other embodiments (see FIGS. 3a, 3b, 7a and 7b) of braking systems with two brake modules in the version with an accumulator chamber and the brake module and is not described separately again below.

FIG. 2c shows the advantageous connection of the valve seat VS (e.g. in FIG. 5a) and the armature chamber of the isolating valves TV1, TV2 to the brake circuits BK1, BK2. Thus, the armature chamber AR (e.g. in FIG. 5a) is hydraulically connected to the pressure generator DV2 of the second brake module BM2 and the valve seat of the special solenoid valves MV2k to the brake circuits. This arrangement allows a valve opening cross-section to be set, in particular by means of PWM control or current control during pressure reduction, thus achieving low-noise pressure reduction. The pressure build-up in this arrangement then takes place via controlled or regulated volume metering using the second brake module BM2, wherein the isolating valves TV1, TV2 are preferably time-controlled during the pressure build-up and the pressure build-up takes place using the multiplex/PPC method.

When using a special solenoid valve MV2k as shown in FIG. 5a, the special current control via an H-bridge (see FIG. 6) also allows the pressure build-up to take place with a variable valve cross-section, so that dead times of the multiplex/PPC method can be avoided and a simultaneous pressure build-up can take place without high demands on the actuator. In this embodiment example, the connection direction is irrelevant, as the special solenoid valve MV2k as shown in FIG. 5a can be throttled in both directions. In addition, it can be operated in such a way that it is passive-closure-proof by applying an appropriate current.

FIG. 3a (short designation ESP-X_{3k, 12 MV, 4 RB, SK, KP}) shows an embodiment example of the first brake module BM1 according to the invention in an embodiment as a three-channel brake system with twelve solenoid valves, four wheel brakes RB1-RB4, accumulator chambers Spk and piston pump, which differs from a standard ESP system in that two inlet valves EV1, EV2 in the first brake circuit BK1 are designed as special solenoid valve MV2k. A parallel connection of non-return valves (see RV in FIG. 1) can be dispensed with due to the special passive-closure-proof properties of these valves.

In one embodiment example, the special solenoid valves MV2k are equipped with redundant solenoid coils MS1, MS2 and redundant solenoid valve drivers, so that redundant operation is possible, or a solenoid valve driver can be controlled via the primary control unit M-ECU. In the embodiment example shown, the first brake circuit BK1 corresponds to the front axle brake circuit of a vehicle with a II brake force distribution. This means that the wheel brakes RB1, RB2 are the wheel brakes of the front axle VA of a vehicle.

In an alternative embodiment example, an X brake circuit distribution can be selected. In a minimum configuration, the inlet valves EV1, EV2 assigned to the wheel brakes RB1, RB2 of the front axle VA can be designed as special solenoid valves MK2k in this embodiment example. Significant improvements can be achieved by this modification of a standard brake system, as a 2-circuit brake system becomes a 3-circuit brake system, wherein for two-wheel brakes (cf. wheel brakes RB1, RB2 in FIG. 3a) redundancy is given during pressure build-up and pressure reduction. In contrast to the prior art, if one of the first- or second-wheel brakes RB1, RB2, e.g. the wheel brake RB1, fails, the respective wheel brake circuit can be disconnected by closing the inlet valve EV1 assigned to the defective wheel brake RB1. This means that normal operation can be continued with the three remaining wheel brake circuits comprising the wheel brakes RB2-RB4. In addition, if a solenoid coil of one of the outlet valves AV1, AV2 fails, pressure can be relieved redundantly via the respective inlet valve EV1, EV2. This presupposes that the respective driving dynamics system has a controllable pressure sink, e.g. by providing a corresponding second brake module BM2. With this approach according to the invention, significant improvements in the achievable deceleration compared to the prior art can be achieved, since in the event of failure either (a) one wheel brake RB1, RB2 on the front axle VA and two-wheel brakes RB3, RB4 on the rear axle HA or (b) two wheel brakes RB1, RB2 on the front axle VA are available for braking.

The above-described interface between the brake modules in accordance with VDA360 is extended in one embodiment example in such a way that, in addition to the interfaces described in DE102012211278A1, the inlet valves EV1 to EV4 can also be actuated externally. This means that if one wheel circuit fails, yaw rate control (ESP), torque vectoring via wheel-specific braking torque intervention (BtTV) and selective braking torque intervention for steering (BtS) is possible with the three remaining brake circuits. This approach according to the invention also has the advantage that all functions according to the above table can be retained without major software changes, particularly in the first brake module BM1. The software components responsible for the pressure build-up must be modified in such a way that the additional function of the 3-circuit control is available in the event of a wheel circuit failure. Furthermore, a control strategy that enables the primary control unit M-ECU to set a pressure can be implemented with little development effort, as a pressure can be maintained at two-wheel brakes RB1-RB4 by the special solenoid valve. In this way, pressure can be built up and released Individually for each wheel by means of the specially equipped inlet valves EV1-EV4 using the second brake module BM2. With wheel-specific brake torque control or brake torque control, there is no need to reduce the pressure via the outlet valves AV1-AV4 (Implementation of all isolating valves TV1-TV4 with special solenoid valves as shown in FIG. 3b) or the outlet valves AV1, AV2 (implementation as shown in FIG. 3a) and there is no need for time-consuming reclaiming of the brake fluid by means of the pump P. If there is no need for reclaiming, the complex pressure oscillation compensation by the second brake module BM2 can also be dispensed with during recirculation by the first brake module BM1, which has a beneficial effect on noise and wear.

A blending strategy for 2-box brake systems is described in WO2018234387A1 (pages 23-25) and can also be used for wheel-specific brake torque control or brake torque control for torque vectoring or steering interventions. With the special solenoid valves MV2k, blending strategies or wheel-specific braking torque interventions can be implemented much more easily. Furthermore, degrees of freedom are created because the pressure in a wheel brake RB1-RB4 can be maintained if the pressure supply unit of the second brake module BM2 sets a different pre-pressure for a different wheel brake.

In one embodiment example, the first brake module BM1 can be extended by two non-return valves RV1, RV2, which are part of a connection between the pumps P of the brake circuits BK1, BK2 and the reservoir VB (see dashed connection in FIG. 3a). Compared to the prior art, this enables fast priming by the pump, significantly faster than the priming process via the valves HSV1, HSV2 and other hydraulic resistances as a result of the combination with a second brake module BM2.

FIG. 3b (short designation ESP-X_{4k, 12 MV, 4 RB, SK, KP}) Shows the first brake module BM1 according to the invention as a 4-channel brake system with twelve solenoid valves, four wheel brakes RB1-RB4, accumulator chambers Spk and piston pump KP, which differs from a standard ESP in that in both brake circuits BK1, BK2 all inlet valves EV1-EV4 and their non-return valves RV1-RV4 (see FIG. 1a) are each replaced by a special solenoid valve MV2k. In this embodiment example, a 4-circuit braking system is created. The embodiment example creates further degrees of freedom for wheel-specific braking torque control and provides a simple pressure interface to the primary control unit M-ECU. By creating a 4-circuit brake system in the first brake module BM1, it is possible to dispense with a brake circuit split in the second brake module BM2. For example, the second brake module can comprise a simple master brake cylinder (HZ) with only one piston (so-called single master brake cylinder SHZ) and a pressure chamber, as described in WO2020165294A2, wherein the master brake cylinder is preferably designed with redundant seals, wherein the SHZ only has to be connected to one brake circuit, e.g. the front axle brake circuit. If a wheel circuit in the first brake module fails, it is only necessary to ensure that the defective wheel brake circuit is disconnected if the pumps P also fail. According to the invention, this can be carried out by the respective inlet valves EV1-EV4, which can be controlled internally and externally. For this purpose, the special solenoid valves MV2k are equipped with redundant coils and solenoid valve drivers.

FIG. 4a shows a first advantageous embodiment of a passive-closure-proof and bidirectionally effective currentless open solenoid valve MV2k. According to the invention, the term “bidirectional” can be understood to mean that pressure build-up and pressure reduction take place via the MV2k valve. The special solenoid valve MV2k functions reliably in both flow directions Q, especially with large flow rates, e.g. 100 cm³/s-120 cm³/s, and large pressure differences between the connections, e.g. 160 bar-220 bar.

The special solenoid valve MV2k has the typical structure of a solenoid valve with electromagnetic circuit EM1, armature 6, valve actuator 7, comprising a valve tappet 7a, which closes a valve seat VS. Furthermore, a return spring RF is provided, which has a linear force curve and acts on the valve actuator 7. The return spring pretensions the special solenoid valve MV2k into an initial position (position shown in FIG. 4a).

Particularly for the range of large pressure changes and flow rates described above, the special solenoid valve MV2k ensures that it does not close automatically due to the effects of dynamic flow forces. These are critical when there is a high pressure at the armature chamber AR and a low pressure at the hydraulic connection acting on the valve seat VS. The hydrodynamic flow creates a force F_{hyd} that acts on the valve tappet in such a way that the valve tappet is moved in the direction of the valve seat VS. The return spring RF counteracts the dynamic flow forces, but in extreme cases is not sufficient to actively prevent passive closure under the influence of dynamic flow forces.

The magnetic circuit EM1 generates (see FIG. 4b) a current-dependent and position-dependent magnetic force F_{EM1}=f (I_{SP}) over the stroke s, which moves the armature in the direction of the stop and the valve tappet 7a in the direction of the valve seat VS. The magnetic force curve is non-linear and increases progressively with increasingly small air gap S (FIG. 4a), in particular with a polynomial formula with FM_{EM1}=(Sₘₐₓ−S)ⁿ, n=1.4-2 with increasing stroke s or decreasing air gap S between armature 6 and stop (smax-s). The magnetic force can be increased with higher current isp, but is limited by the saturation of the magnetic circuit. However, the magnetic force can only act in the direction of the valve seat VS and therefore cannot generate a counterforce to a hydrodynamic force F_{hyd} if the flow Q originates from the armature chamber. If the valve is closed, the valve can remain active when energized against a pressure acting on the valve seat. If the flow acts from the valve seat VS, a counterforce can be generated, meaning that operation with a variable opening cross-section is also possible, I.e. the special solenoid valve MV2K is operated with a variable valve opening cross-section comparable to a proportional valve. In technical jargon, this type of control is also referred to simply as PMW control.

In order to make the special solenoid valve MV2k passive-closure-proof, a permanent magnet PM is provided in a first variant as a passive additional force device to increase the restoring force F_{RF}, caused by the return spring RF. A permanent magnetic circuit comprises the permanent magnet PM and a pole plate 10. The permanent magnet is integrated into an additional armature 6a, which is non-positively connected to the armature 6. The poles are aligned parallel to the longitudinal direction of the special solenoid valve MV2k, so that the magnetic force Fpm of the permanent magnet PM acts in addition to the restoring force F_{RF}: total force F_{ges}=F_{PM}+F_{RF}.

The magnetic force F_{PM} is characterized in that the force is high when the valve is open and decreases as the stroke s increases. At the end of the stroke S=sₘₐₓ, the magnetic force F_{PM} is still high enough to perform the usual armature reset. With the appropriate design, the return spring 13 can be replaced if it is also taken into account that the magnetic force FEM1 generated via the coil SP2 and the primary magnetic circuit EM1 is large enough to overcome the counterforce from the permanent magnet or return spring, which can be achieved by shaping the characteristic curve of the EM magnetic circuit accordingly.

In addition, or as an alternative, an additional restoring force to the first electromagnetic circuit EM1 can also be generated by a second electromagnetic circuit EM2. The second electromagnetic circuit EM2 is generated by current in a second coil SP2, wherein the field runs through the additional armature 6a, which is preferably made of ferromagnetic material. This means that a force is also generated in this variant which, like the restoring force F_{RF} of the return spring RF, acts against the hydrodynamic force F_{hyd}. In this variant, the armature 6 is also mechanically coupled to an additional armature 6a.

In one embodiment example, the return spring RF can be dispensed with if the additional force device is dimensioned accordingly.

A key aspect of the special solenoid valve MV2k is that the total force FGes is essentially linear over the entire stroke. Preferably, the force is increased when leaving the starting position or home position. A characteristic force distribution over the stroke s is shown in FIG. 4b. The figure also illustrates that the special solenoid valve MV2k according to the invention has a significantly different force distribution (cf. FGes) than valves conventionally used in this area (cf. restoring force F_{RF}).

FIG. 5a shows a second advantageous embodiment example of a special solenoid valve MV2k, which is passive-closure-proof, bidirectionally effective and normally open. The special solenoid valve MV2k is suitable for the described use in the first brake module BM1 (as inlet valve EV1-EV4) and in the second brake module BM2 (as isolating valve TV1, TV2).

The special solenoid valve MV2k has the typical design of a solenoid valve with electromagnetic circuit EM1. It has an armature 6, a valve actuator 7 with valve tappet 7a and a valve seat VS. In the embodiment example, a ring-shaped permanent magnet PM is integrated into the armature 6, which is encased by soft magnetic elements (flux conductor). The permanent magnet PM is aligned with its poles transverse to the longitudinal direction of the special solenoid valve MV2k. Alternatively, a plurality of correspondingly radially aligned permanent magnets PM can also be provided. An electromagnetic field EM1 is generated by means of an excitation current through a coil SP1a, which extends in circular paths within a section of the housing of the special solenoid valve MV2k. The electromagnetic circuit EM1 extends over the housing, a left leg leads over a first air gap via the flux conductor in the armature and closes over a second air gap with a right leg, wherein both legs are arranged on the housing and are ferromagnetically conductive. The left and right legs are separated from each other by a large air gap so that the electromagnetic field does not close directly from the left to the right leg. When energized, magnetic poles are formed in the legs, which either attract or repel the permanent magnet PM depending on the direction of the current through the excitation coil SP1a and thus in the magnetic flux direction.

In the embodiment example, the remaining armature 6 is made of electromagnetically non-conductive material. For example, it can be made of an Inexpensive plastic part, which preferably also comprises the valve actuator 7. In the initial position, the armature 6 is positioned so that the flux conductor is closer to the left leg than to the right leg. As a result, the armature 6 experiences a valve-opening force effect that is comparable to the force effect of the magnetic force F_{PM} and/or restoring force FRF of FIG. 4a. This makes it possible to dispense with a return spring RF. In addition, the restoring force via the flux conductor is subject to fewer tolerances in relation to a return spring RF, as the design of solenoid circuits is easily reproducible.

In the embodiment example shown in FIG. 5a, the excitation coil SP1a is controlled via an H-bridge (see FIG. 6) with four power semiconductors. This makes it possible to change the magnetic flux direction by reversing the current direction. The electromagnetic field EM1 can thus increase or reduce the force acting on the permanent magnet PM. The field can also be reversed so that the special solenoid valve MV2k closes. As a result, the armature 6 can be moved to the right or left in the image plane via current regulation or current control,

The described embodiment example has the advantage that the valve has a very simple structure. As can be seen from FIG. 6, the H-bridge comprises four power semiconductors and the magnetic flux direction can be determined depending on how the power semiconductors are switched. If power semiconductors S2 and S3 are switched, a current 11, 12 generates a first magnetic flux direction so that a north pole forms on the left leg and a south pole forms on the right leg and the armature 6 is magnetically repelled, i.e. the valve is closed. If power semiconductors S1 and S4 are switched, a current i3 generates a second magnetic flux direction, so that a south pole is formed on the left leg and the armature is retracted, i.e. the valve is opened or held in the open position. Due to the control according to the invention via an H-bridge, the restoring force can even be increased by the permanent magnet PM, which means that the valve is extremely passive-closure-proof and can also be opened very quickly. The fast opening has the advantage that dead times during pressure reduction due to the opening process of the valves, which are typically 2 ms, can be reduced to less than 1 ms. This enables rapid pressure reduction without loss of time, which has a beneficial effect on ABS control quality and braking distance. Furthermore, the cross-section of the special solenoid valve MV2k can be controlled very precisely during pressure build-up, and large valve opening cross-sections with the advantage of reduced throttling effect with large valve strokes can be easily realized with the approach. With the control according to the invention via an H-bridge, the special solenoid valves MV2k can be operated in a current-controlled manner with a variable valve cross-section both during pressure build-up and pressure reduction. This enables particularly low-noise and high-precision pressure control during both pressure build-up and pressure reduction.

In one embodiment example, the special solenoid valve MV2k is equipped with a large cross-section, which significantly reduces the throttling effect during pressure build-up. This allows the time until the blocking pressure is reached to be shortened.

The special solenoid valves MV2k described offer the possibility of dispensing with several outlet valves AV1-AV4, in particular dispensing with two outlet valves on the wheel brakes RB3, RB4 of a rear axle HA, because 2-channel multiplex operation is very easy to realize with such valves.

FIG. 5b shows a diagram illustrating the magnetic force FEM1 acting on the armature 6 (cf. VK for biasing force and RK for restoring force) over the distance s. The dashed line sₘₐₓ is the maximum distance at which the valve tappet 7a closes the special solenoid valve MV2k. If the special solenoid valve MV2k is not energized (i=0), this results in a relatively high restoring force in the starting position (s=0), which decreases over the distance s. However, a restoring force still acts in the closed position (s=smax; valve is closed) so that unintentional passive closure of the valve is prevented. When energized with a negative sign (see i=(3), a significantly stronger restoring force results over the entire distance s.

With a weak energization with a positive sign (i=(3), there is only a restoring force in the positions close to the initial position. Once this restoring force has been overcome, a biasing force acts to force the valve tappet into the closed position. In the case of strong energization with a positive sign (i=13), a biasing force acts over the entire path s so that the special solenoid valve MV2k can be closed in a controlled manner.

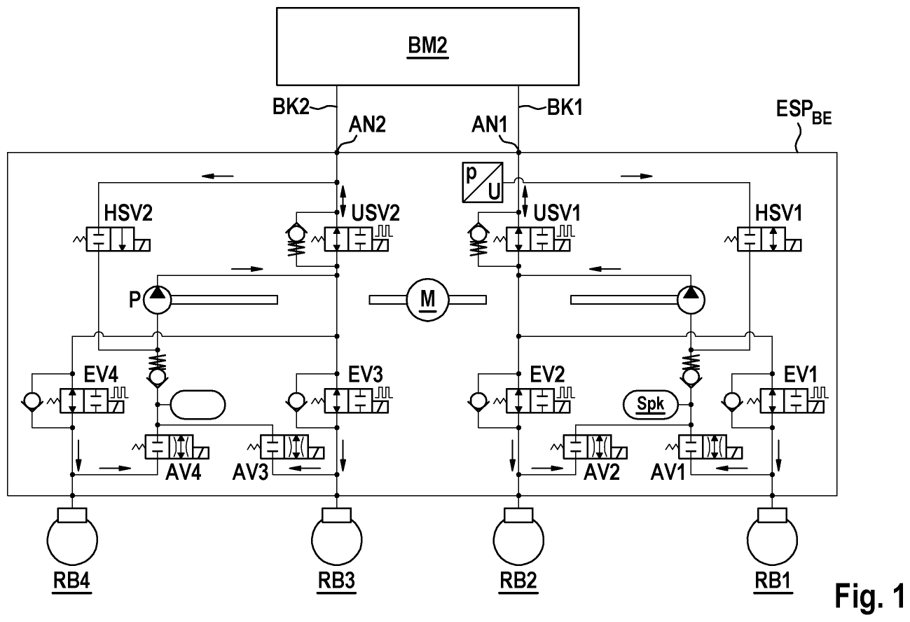

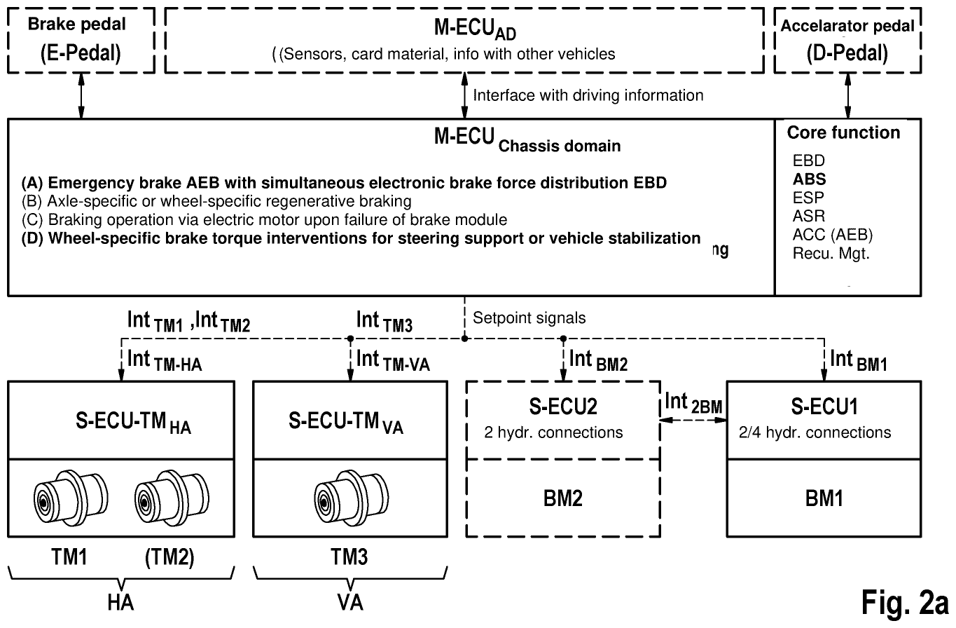

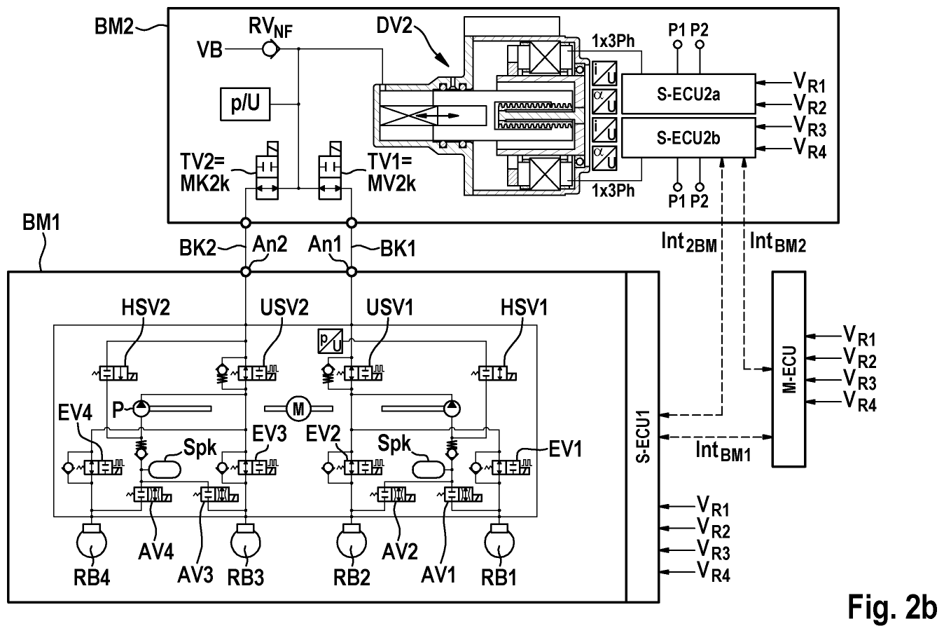

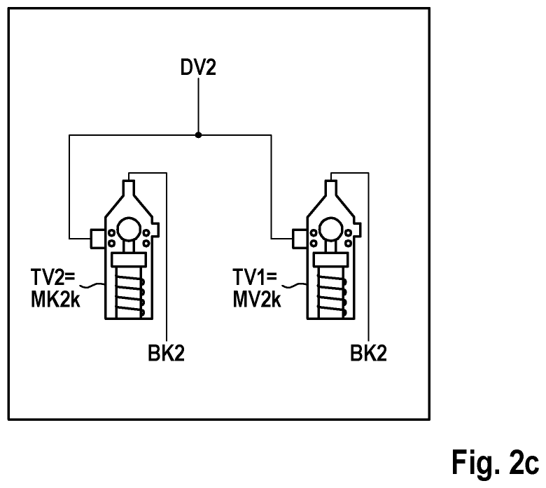

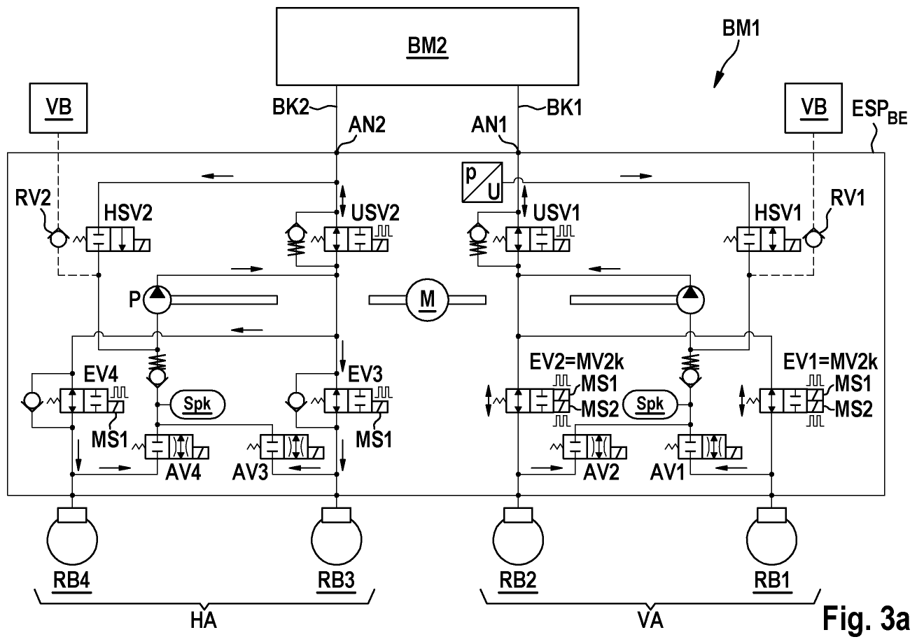

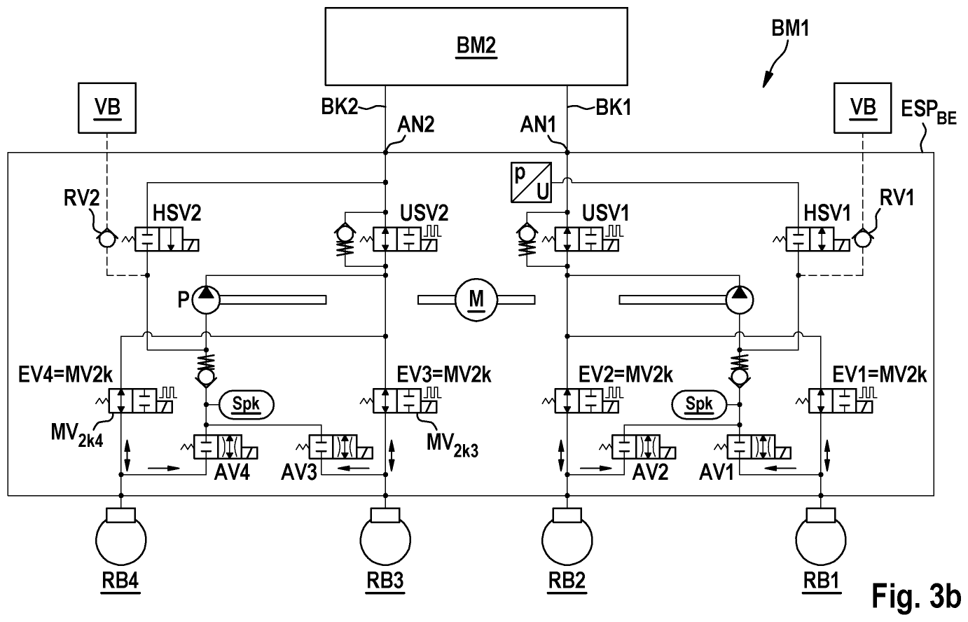

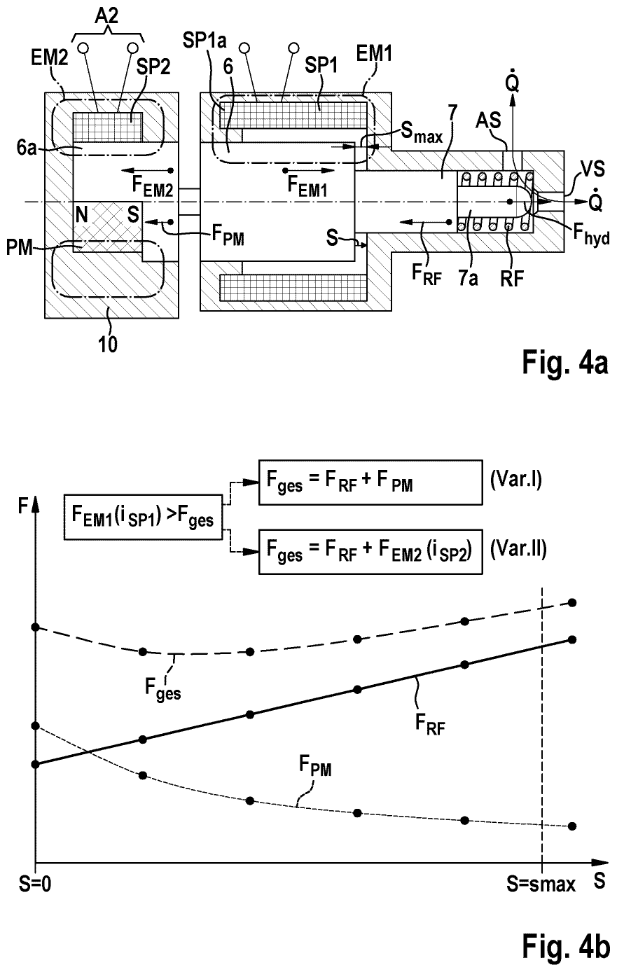

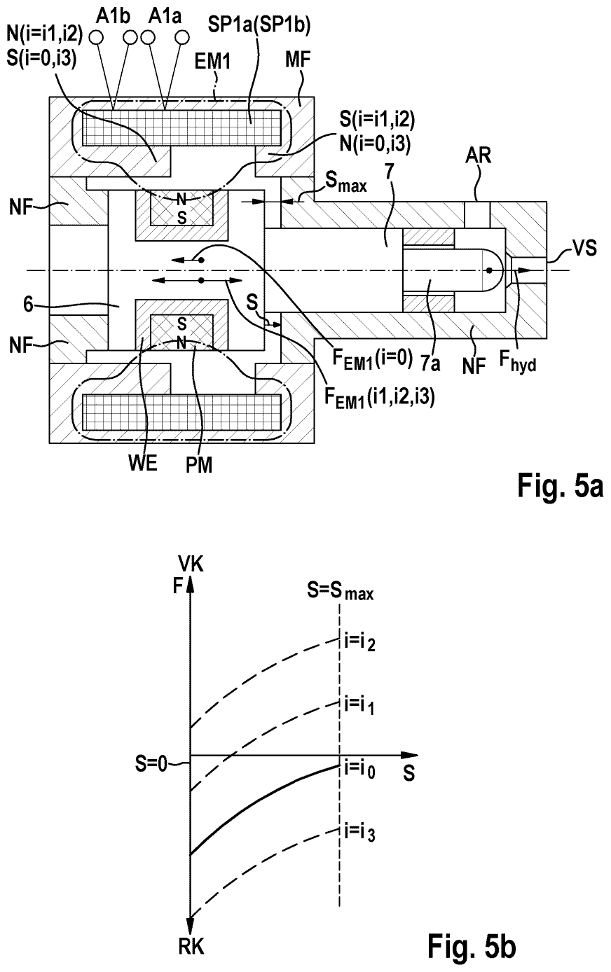

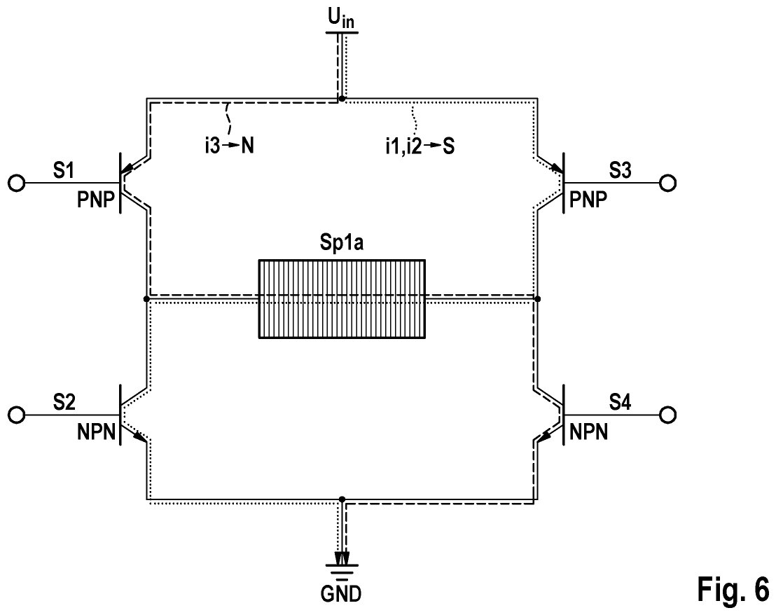

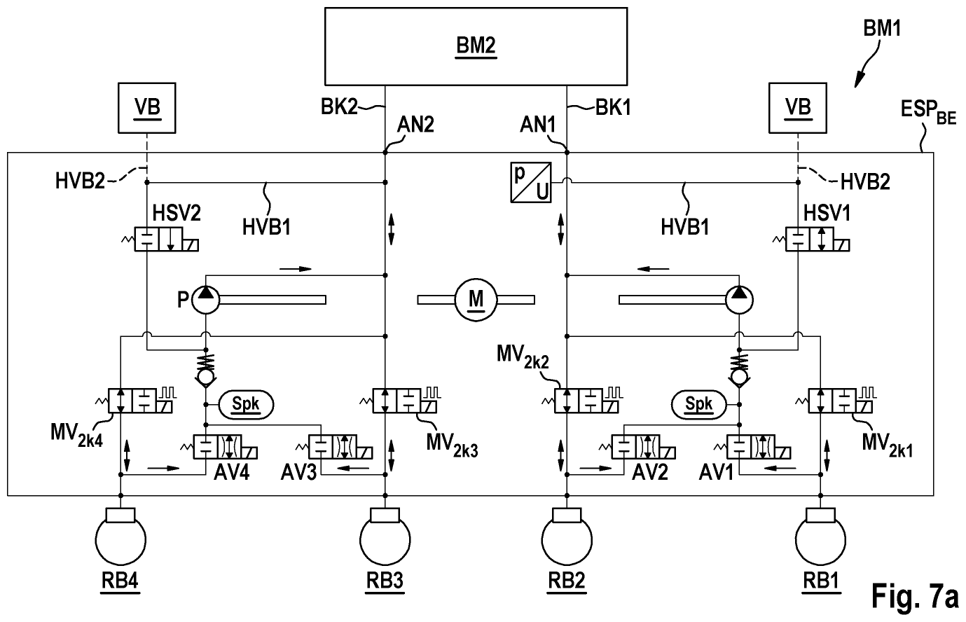

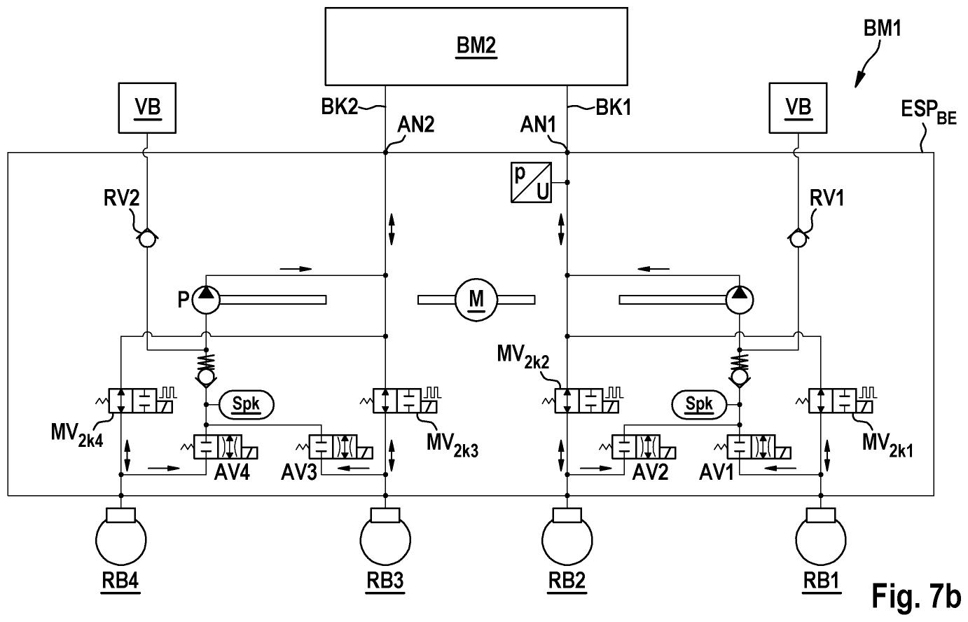

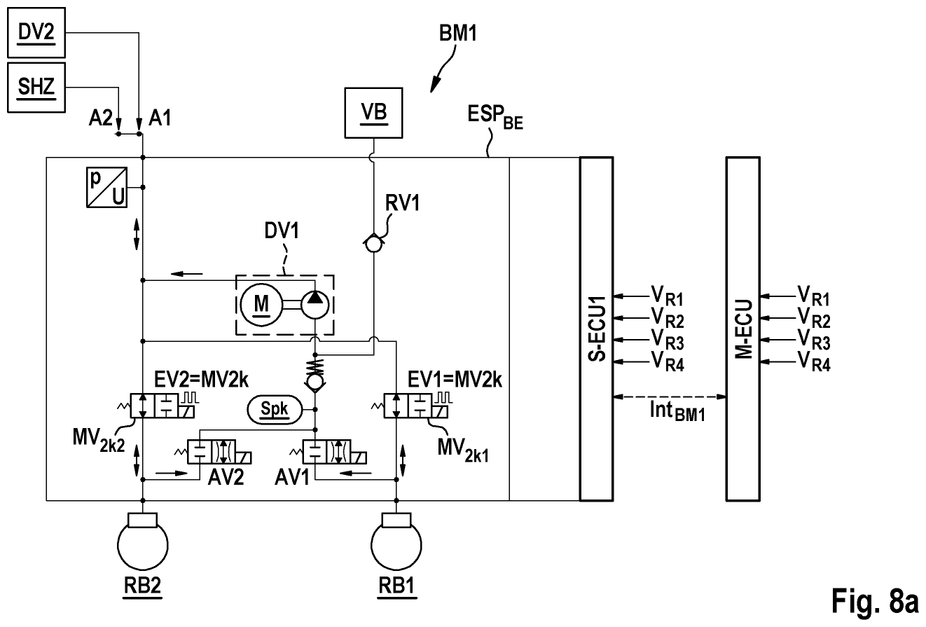

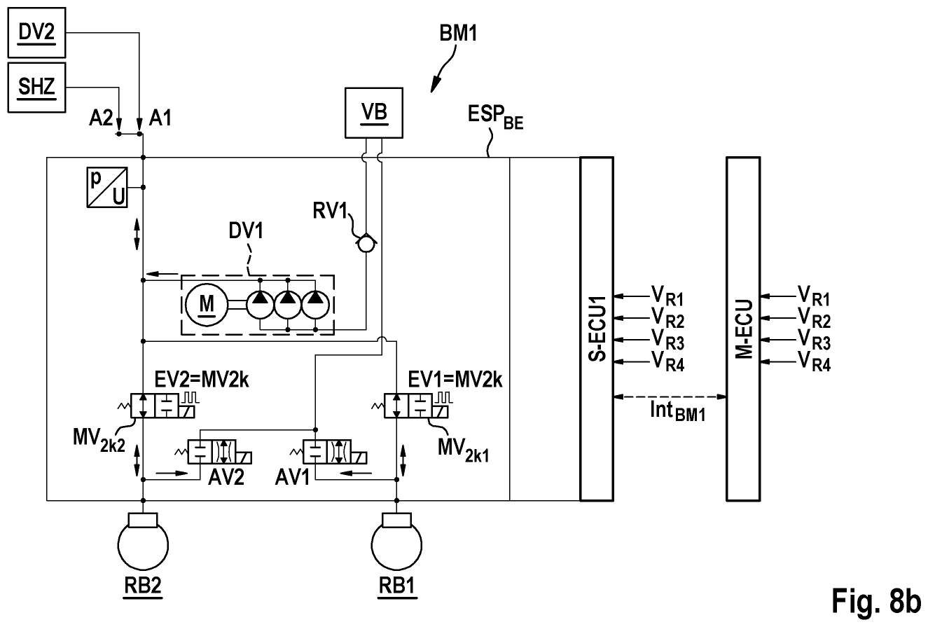

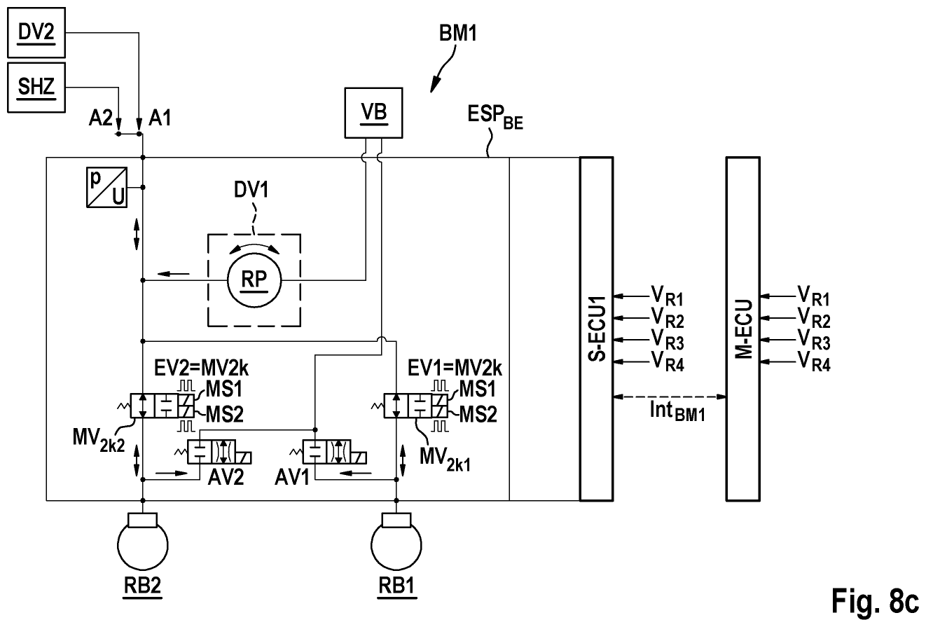

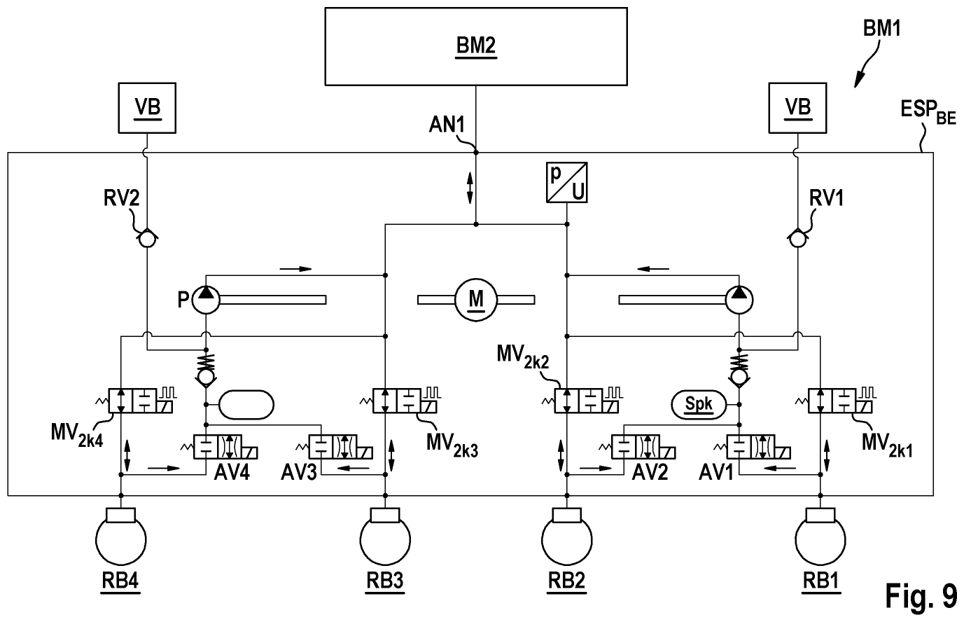

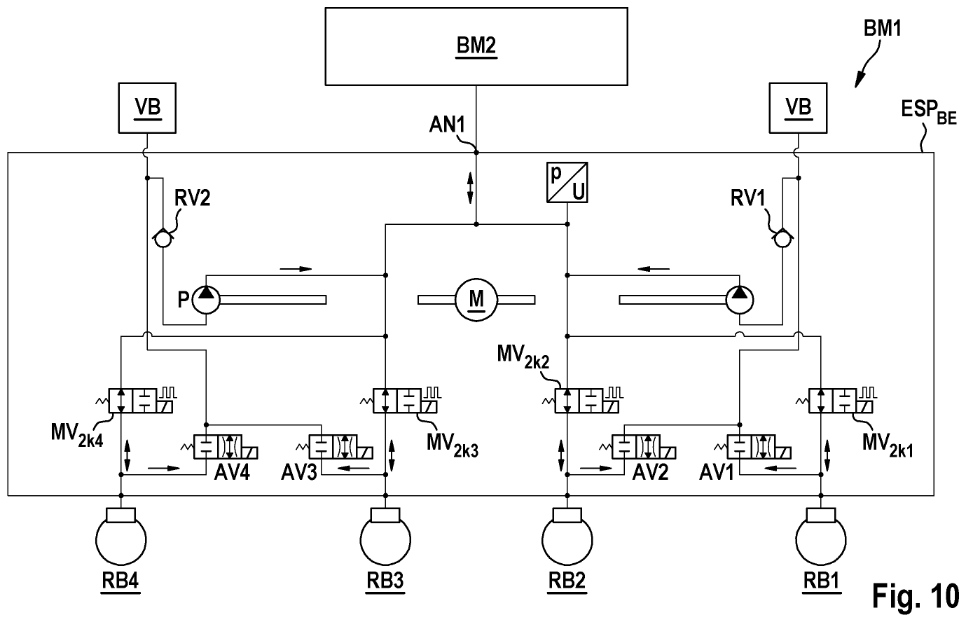

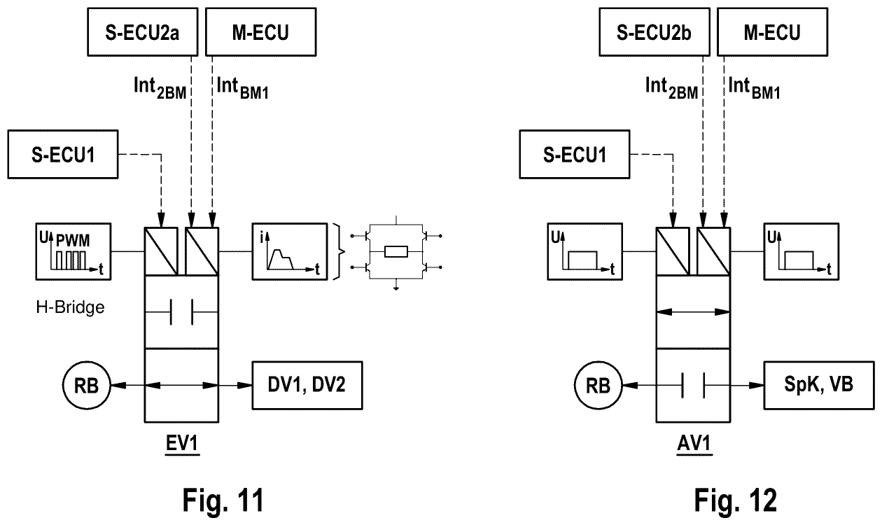

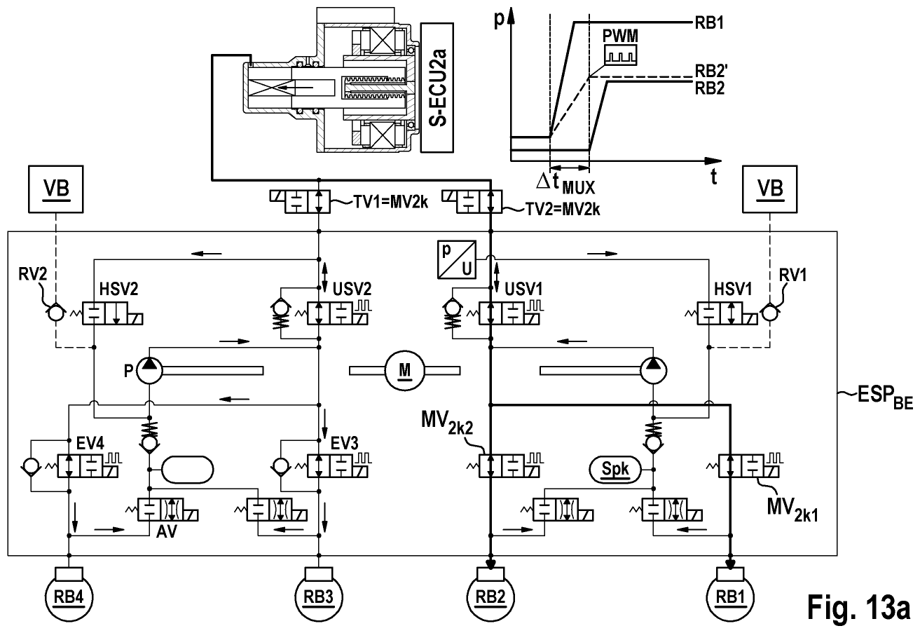

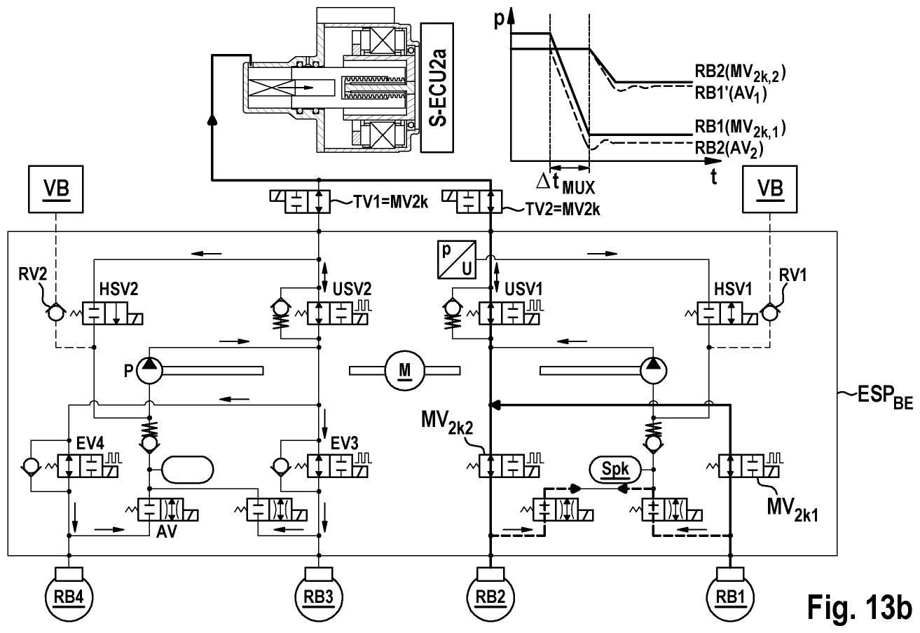

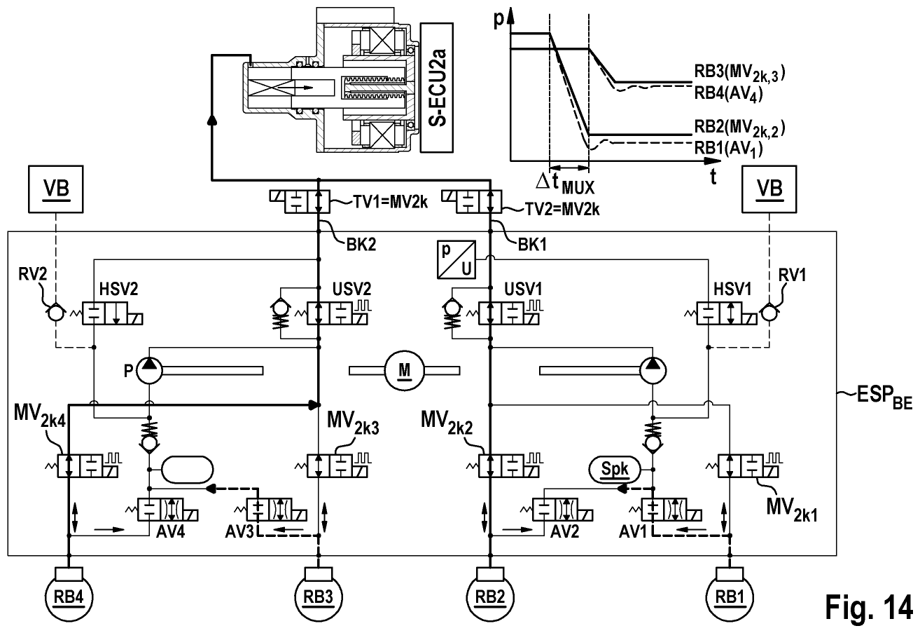

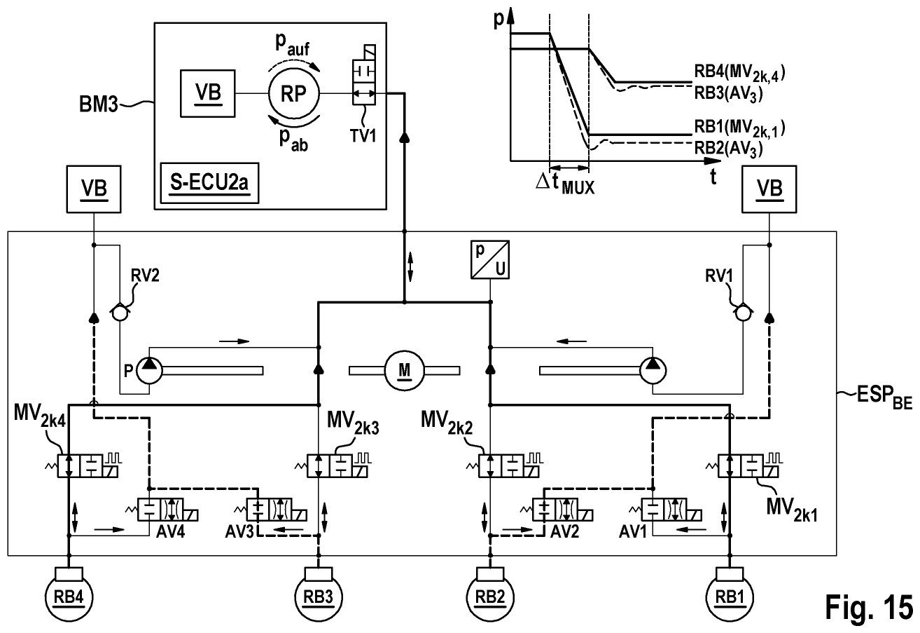

FIG. 7a (short designation ESP-X_{4k, 10 MV, 4 RB, SK, KP}) Shows a further embodiment example of the first brake module BM1, in which the valves USV1, USV2 are dispensed with without this leading to functional restrictions. The brake module has four circuits, ten solenoid valves, four-wheel brakes and two accumulator chambers Spk. This assumes that the first brake module BM1 is operated with a second brake module BM2, which supplies two separate brake circuits BK1, BK2 and has isolating valves TV1, TV2 in the form of special solenoid valves MV2k (e.g. as shown in FIG. 2b). The isolating valves TV1, TV2 then take over the function of the valves USV1, USV2, particularly in the case of ESP interventions. To implement this solution, a further interface between the brake modules BM1, BM2 is required. The advantage of this approach is that the throttle resistances between the pressure generator DV2 of the second brake module BM2 and the wheel brakes RB1-RB4 are reduced, making the system even more responsive, which has a positive effect in the event of emergency braking, for example.

FIG. 7b (short designation ESP-X_{4k, 8MV, 4 RB, SK, KP}) shows a first brake module BM1 in which the valves USV1, USV2 and the valves HSV1, HSV2 are dispensed with. The brake module has four circuits, eight solenoid valves, four-wheel brakes RB1-RB4, two accumulator chambers Spk and a piston pump KP. To implement the functions of the valves HSV1, HSV2, two non-return valves RV1, RV2 are provided, which establish a connection to the reservoir VB. This leads to a further reduction in costs without functional restrictions and without limiting the range of functions.

FIG. 8a (short designation ESP-X_{2k, 4 MV, 2 R8, SK, KP}) Shows an embodiment example that is a modification of the embodiment example shown in FIG. 7b. Only four valves (two inlet valves, two outlet valves) are required for this. A first brake module can be used for a two-wheeled vehicle or an axle of a vehicle with several axles. It has connections for exactly two-wheel brakes RB1, RB2, wherein each wheel circuit can be separated separately via the special solenoid valves MV2K, which are used as isolating valves TV1, TV2.

If a wheel brake RB1, RB2 fails, the remaining wheel brake circuit can still be operated and a braking torque can be applied or reduced. This first brake module BM1 preferably also provides an interface IntBM1 to the primary control unit M-ECU, so that target specifications for wheel-specific braking torque interventions can be specified directly via the primary control unit M-ECU. The first brake module BM1 functions independently with standard pressure setting mode (pressure control method A); pressure control method B can also be used with an additional pressure supply DV2. A separately designed pressure generator DV2 or a second brake module BM2 can be hydraulically connected to the brake module BM1 in connection A1, A2 or a SHZ can be connected. As shown in FIG. 2b, it is also possible to switch between a standard pressure setting mode and a special pressure setting mode I in ABS mode.

FIG. 8b (short designation ESP-X_{2k, 4 MV, 2 RB, VB, MKP}) shows a further embodiment example of the first brake module BM1 for two-wheel brakes RB1, RB2, wherein the pressure generator is a pump with several pistons. The pressure is reduced via the outlet valves AV1, AV2 directly into the reservoir VB. This has the advantage for the control system that the control at low pressures, in particular when controlling snow and ice, can be significantly improved because the back pressure of the storage chamber SpK does not limit the pressure gradients during pressure reduction. In this embodiment, the special pressure setting mode I is not required. In this embodiment, the special pressure setting mode I is not required.

The first brake module BM1 preferably also provides an interface IntBM1 to the primary control unit M-ECU, so that target specifications from VMC for wheel-specific brake torque interventions can be specified directly via the primary control unit M-ECU. The first brake pressure module BM1 functions autonomously with pressure control method A; pressure control method B can also be implemented with an additional pressure generator DV2.

FIG. 8c (short designation ESP-X_{2k, 4 MV, 2 RB, VB, MKP}) shows an embodiment example similar to that shown in FIG. 8a with a first brake module BM1 for two-wheel brakes. A rotary pump RP is provided as pressure generator DV1, by means of which pressure can be built up and pressure can also be released by reversing the direction of rotation. The special solenoid valves MV2k arranged as inlet valves EV1, EV2 and connected to the wheel brakes RB1, RB2 are equipped with redundant excitation coils and redundant drivers. In general, corresponding redundant equipment is possible in all embodiments of the invention.

The two outlet valves AV1, AV2, which are each associated with a wheel brake RB1, RB2, are hydraulically connected to the reservoir VB for effective pressure reduction. The embodiment example is very advantageous in that there are several degrees of freedom for pressure reduction, which can be used either to improve availability in the event of partial failure or to Improve control and pressure control options. For example, the pressure can be reduced completely independently—from the perspective of the first brake module BM1—via the outlet valves AV1, AV2. In addition, pressure can be built up and reduced by means of an external pressure generator DV2, which is provided separately or as part of a second brake module BM2. This embodiment example is therefore particularly suitable for use as a cost-effective axle module, which is preferably controlled centrally.

In general, the rotary pump RP can be used additionally or alone as the first pressure generator DV1 or as the second pressure generator DV2 in all the embodiment examples described. When used in the first brake module BM1 as the first pressure generator DV1, the non-return valve RV1 (see e.g. FIG. 3b) between the pump and the reservoir VB can be omitted. One advantage of pressure reduction via the rotary pump RP is that the pressure reduction gradients are not limited by the back pressure of the accumulator chamber Spk and can be used to improve the ABS control performance at low-even without an external pressure generator DV2.

The first brake module BM1 as shown in FIG. 3b preferably also provides an interface Int_{BM1} to the primary control unit M-ECU, so that target specifications from VMC for wheel-specific braking torque interventions can be specified directly via the primary control unit M-ECU. The first brake module BM1 functions independently with pressure control mode A or special pressure setting mode II (rotary pump acts as a pressure sink). Pressure control mode B (special pressure setting mode I) can also be implemented with an additional pressure generator DV2.

FIG. 9 shows an embodiment example similar to that in FIG. 8a. In this embodiment example, a (single) hydraulic connection is provided for a second brake module BM2. The advantage of the 4-circuit design is utilized by using the special solenoid valves MV2k on (all) four-wheel brakes RB1-RB4 in such a way that a brake circuit separation can be dispensed with.

The embodiment example preferably also provides an interface Int-BM1, not shown, to a central control unit, preferably in the form of the primary control unit M-ECU, so that target specifications for wheel-specific braking torque interventions can be specified externally. The first brake module BM1 described functions independently with pressure control method A and can be expanded with a second brake module BM2 to include pressure control method B (special pressure setting mode I),

FIG. 10 shows a further embodiment example of a modification of the embodiment example shown in FIG. 9. The embodiment example does not have an accumulator chamber Spk. For pressure reduction, the wheel brakes RB1-RB4 are hydraulically connected to the reservoir VB via outlet valves AV1-AV4. Only one hydraulic connection is provided for connecting a second brake module BM2. The hydraulic design is similar to that of the embodiment examples shown in FIGS. 8b and 8c. However, this first brake module BM1 is designed for four-wheel brakes. This embodiment is suitable as a central hydraulic pressure regulator, which is controlled via a central computer, for example the primary control unit M-ECU.

This first brake module BM1 has an optional Int_{BM1} interface (not shown) to the primary control unit, so that target specifications for wheel-specific braking torque interventions can be specified externally. It functions independently with pressure control method A and pressure control method B.

FIG. 11 shows an example of a first inlet valve EV1, as can be used in some or all of the embodiment examples described. The inlet valve EV1 is designed as a special solenoid valve MV2k and has redundant coils, each of which is energized via a driver, The first driver (left) is electrically connected to the secondary control unit S-ECU1 of the first brake module BM1, in which the respective inlet valve is used. The second driver (right) is connected to two interfaces Int_{2BM} and INT_{BM1} so that it can be controlled by at least one of the secondary control units S-ECU2a of the second brake module BM2 and the primary control unit M-ECU.

In one exemplary embodiment, the secondary control unit S-ECU1 implements PWM control with pulse width modulation, i.e. clocking of the voltage. A simple switch is sufficient for this. Control by the primary control unit M-ECU or by the second brake module BM2 is preferably achieved by means of current control i=f (t). The H-bridge already described can be used for this purpose. The H-bridge can be used to regulate the current flow over time and there is a greater degree of freedom, particularly for valve cross-section control with a variable cross-section, both during pressure build-up and, with the appropriate design, also during pressure reduction. In this way, pressure can be built up and released quietly. Depending on the embodiment example, the H-bridge can be used as the first or second driver. Alternatively, both drivers can also be operated via a PWM control.

FIG. 12 shows an outlet valve AV1 as it can be used in one or all of the embodiment examples described. The outlet valve AV1 has redundant coils, each of which is energized via a driver. The first driver (left) is electrically connected to the secondary control unit S-ECU1 of the first brake module BM1, in which the respective outlet valve AV1 is used. The second driver (right) is connected to two interfaces Int_{2BM} and INTBM1 so that it can be controlled by at least one of the secondary control units S-ECU2a of the second brake module BM2 and the primary control unit M-ECU.

The outlet valve AV is preferably operated in time control mode, in which the opening time is controlled via the voltage U=f (t).

FIG. 13a and FIG. 13b show a pressure build-up (FIG. 13a) and a pressure reduction (FIG. 13b) via the second brake module BM2 to illustrate the function of the brake modules BM1, BM2 from FIG. 3a. The respective volume flows are marked schematically. In the top right-hand corner are pressure diagrams over time (t), which visualize the pressure curve in the wheel brakes RB1, RB2.

In the embodiment example shown in FIG. 13a, the pressure build-up takes place either sequentially according to pressure control method B (MUX) in the multiplex/PPC method with a delay time Δtₘᵤₓ or by means of pressure control method A (EV_{PWM}), in which the pressure build-up takes place simultaneously in several wheel brakes RB1, RB2 via a pre-pressure control. In the latter method, one valve, e.g. the inlet valve EV1, is preferably open and the other valve, e.g. the second inlet valve EV2, is PWM-controlled. Alternatively, both inlet valves EV1, EV2 can be operated with different PWM frequencies or current profiles for different valve opening cross-sections in order to set different pressures in the wheel brakes RB1, RB2 for a given inlet pressure.

The pressure reduction at the wheel brakes RB1 and RB2 is shown as an example in the pressure reduction according to FIG. 13b. The pressure is reduced either sequentially according to pressure control method B (MUX) in the multiplex/PPC method in the closed hydraulic circuit via the special solenoid valves MV2k with a delay time Δtₘᵤₓ or by means of pressure control method A (standard pressure setting mode) with an open hydraulic circuit via the outlet valves AV1, AV2. In this way, the pressure from a wheel brake RB1 can be reduced using the multiplex/PPC method and the pressure in the wheel brake RB2 can be built up in parallel via outlet valves. If a very fast pressure reduction is required, the pressure can also be reduced in parallel via outlet valves and special solenoid valves using the special pressure setting mode II not shown. If an outlet valve fails, it is possible to switch from pressure control method A on a wheel brake to the multiplex/PPC method. Thanks to the alternatives and degrees of freedom, very good control performance can be mapped for every critical driving situation and redundant 4-channel operation is also possible.

FIG. 14 shows the pressure reduction in one design of the brake modules BM1, BM2, as explained in FIG. 3b. The volume flow is marked schematically. In the top right-hand corner there is a pressure diagram over time (t), which visualizes the pressure curve in the wheel brakes RB1, RB2, RB3, RB4.

According to the control strategy visualized here, the pressure reduction can take place according to pressure control method B in the multiplex/PPC method with a delay time Δtₘₐₓ or via pressure control method A. In the MUX method, the target pressure is set via the piston-cylinder unit, which is lower than the pressures in the wheel brakes RB1-RB4. The simultaneous reduction via the outlet valves AV1-AV4 into the accumulator chamber without delay time means that the delay time Δtₘₐₓ can be avoided. This means that the control system is not expected to cause any restrictions in critical driving situations. In addition, the first brake module BM1 can be optimized with regard to noise by controlling large pressure gradients with the MUX method and thus not exhibiting any noise-generating vibrations and realizing small pressure gradients with the pressure control method A.

FIG. 15 shows a solution according to the invention with two pressure supply units in the simplest and most cost-effective version. As in FIG. 10, the brake module BM1 is only equipped with eight solenoid valves, wherein all wheel inlet valves are designed with special solenoid valves, Le. a brake module BM1 with four-wheel brake circuits is created here. An electric motor-driven rotary pump is used as the second pressure supply unit instead of an electric motor-driven piston-cylinder unit. Due to the design with four-wheel brake circuits, only one hydraulic connection to the brake module BM1 is required. The brake module BM1 functions independently but is preferably supported by a third BM3 brake module in normal control.

In standard pressure setting mode, the pressure is reduced via outlet valves in the reservoir and in parallel or alternatively via the rotary pump. Due to the corresponding direction of rotation of the rotary pump, the rotary pump acts as a pressure sink during pressure reduction. In addition to the high level of fault tolerance, this embodiment offers many degrees of freedom, in particular the option of switching from standard pressure setting mode (pressure build-up via inlet valves and pressure reduction via timing of the outlet valves) to special pressure setting mode I and/or special pressure setting mode II. If the first brake module BM1 fails, the rotary pump takes over the pressure build-up function, wherein the wheel pressure control valves are simultaneously controlled via a primary control unit M-ECU or another secondary control unit S-ECU2a, S-ECU2b via the communication interfaces (Int_{2BM}, IntBM1) shown in FIG. 11 and FIG. 12.

In the preceding description, the special solenoid valve was (predominantly) described as a special solenoid valve with a force addition device comprising a permanent magnet and/or a second excitation coil and arranged to provide at least one restraining force acting on the valve actuator or the valve tappet. In at least some of the embodiments and embodiment examples described, the special solenoid valve can be any passive-closure-proof solenoid valve. It is therefore conceivable to achieve the resilience to passive closure by providing at least one throttle, which ensures that the volume flow remains so low that the valve does not close.

In general, the passive closure effect can be limited by a pressure differential limitation in the control of the pressure supply unit or preferably by means of a throttle not shown, wherein the throttle is preferably fitted upstream of the armature connection of the valve connection in a hydraulic line.

In some versions of the special solenoid valve, the return spring RF can be dispensed with.

Furthermore, in at least one of the embodiment examples described, the driving dynamics system can be designed in such a way that simple application of the core functions via the primary control unit M-ECU, in particular due to the high computing power, can be automated in the application of the functions during development. In at least one of the embodiment examples described, learning algorithms or artificial intelligence (AI) can be used to support vehicle operation. When using AI, the primary control unit M-ECU can take over the task of the application engineer, which is not possible with prior-art microcontrollers (i.e. one of the regulation/control units of a brake system) due to their very limited performance and limited memory. For example, the central computer records measurement data during vehicle operation, evaluates it and applies various functions, in particular the safety-critical functions ABS, ESP and AEB during vehicle operation or when the vehicle is stationary, when the vehicle is not moving and therefore the adaptation is not time-critical. Therefore, the adaptation is carried out in particular after vehicle operation when the vehicle is parked. Here, the preferable design as a closed hydraulic system with primarily pressure build-up and pressure reduction via bidirectionally acting valves by means of the pressure supply unit has the great advantage that the non-linear relationships can be mapped by suitable sensors via characteristic maps (e.g. pressure-volume curve, relationship between motor current and brake pressure, relationship between brake pressure and deceleration when the wheel brake heats up) and adapted during operation for the detection of environmental influences (e.g. air in the system, heating of the wheel brake). If the non-linear relationships are mapped in mathematical functions or maps, an electrohydraulic brake system can also be applied automatically. If the AI approach is consistently implemented in a hydraulic brake system (EHB), the advantage of the easily adjustable or controllable electromechanical brake (EMB) disappears and the advantages of the lower manufacturing costs of the hydraulic brake system become effective because the disadvantages in the application costs largely disappear.

### LIST OF REFERENCE SIGNS

M-ECU Primary control unit, central computer
R1-R4 Wheel
VR1-vR4 Wheel speed sensors
RB1-RB4 Wheel brake
BK1, BK2 Brake circuit
A1, A2 Connection
BM1 First brake module
BM1BE Assembly unit of the first brake module
DV1 Pressure generator
M Motor
P Pump unit
Spk Accumulator chamber
S-ECU1 Control unit of the first brake module
RP Rotary pump
KP Piston pump
MKP Multi-piston pump
BM2 Second brake module
BM2BE Assembly unit of the second brake module
DV2 Pressure generator
S-ECU2a Control unit of the second brake module
S-ECU2b Control unit of the second brake module
TV1, TV2 Isolating valve
BM3 Additional brake module
RV, RV1, RV2 Non-return valve
AV1, AV2, AV3, AV4 Outlet valve
EV1, EV2, EV3, EV4 Inlet valve
HSV1, HSV2, USV1, USV2 Valves of the ESP unit
MV2k Special solenoid valve for pressure build-up and pressure reduction
TM1 First electrical traction motor for drive of a vehicle axle or a wheel
TM2 Second electrical traction motor for drive of a vehicle axle or a wheel
TM3 Third electrical traction motor for drive of a vehicle axle or a wheel
VB Reservoir
VA Front axle
HA Rear axle
FRF Return force via a spring
FPM Magnetic force
FEM1, FEM2, Magnetic force
PM Permanent magnet
EM1, EM2, Magnetic circuit
RF Return spring
SP1, SP1a, SP1b, SP2 Excitation coil
6 Armature
6a Additional armature
7 Valve actuator
7a Valve tappet
10 Pole plate
13 Return spring
VS Valve seat
AR Armature chamber
MS1, MS2 Solenoid coil
S Air gap
S1-S4 Power semiconductors

1. A driving dynamics system for a vehicle with wheels, comprising:
a primary control unit configured to detect and/or generate steering and braking commands;
at least two hydraulically actuatable wheel brakes, each of which is associated associated with a respective one of the wheels;
at least one electrical traction motor having traction-motor control unit, wherein the at least one electrical traction motor is arranged to drive at least one of the wheels, wherein the primary control unit is communicatively connected to a traction-motor control unit to control the traction motor to implement the steering commands and braking commands;
at least one first electrohydraulic pressure supply unit comprising: with
at least one electric motor-pump unit:
at least two connections to connect the at least one first electrohydraulic pressure supply unit to the hydraulically actuable wheel brakes;
electrically actuatable wheel brake pressure adjustment valves or brake pressure adjustment valves, and
a first secondary control unit;
wherein at least one of the hydraulically actuatable wheel brakes is associated with a brake pressure adjustment valve in the form of a special solenoid valve that passive-closure-proof, and an outlet valve,
wherein the driving dynamics system, via the primary control unit, is designed to release pressure from at least one of the at least two hydraulically actuatable wheel brakes either via the associated outlet valve or via the associated special solenoid valve.

2. The driving dynamics system according to claim 1, wherein the at least one brake pressure adjustment valve is a special solenoid valve having an electromagnetic drive with a first excitation coil, via which a valve actuator or valve tappet is enabled to be adjusted between an open valve position and a closed valve position, wherein the special solenoid valve has an additional force device, in addition to the first excitation coil, which comprises a permanent magnet and/or at least one second excitation coil, and which is arranged to provide at least one retaining force acting on the valve actuator or the valve tappet; and/or wherein the primary control unit is designed to actuate the special solenoid valve and the at least one first pressure supply unit, at least in a selected braking mode, in such a way that pressure is reduced from the at least one hydraulically actuable wheel brake associated with the special solenoid valve when the special solenoid valve is open.

3. The driving dynamics system according to claim 1, wherein the primary control unit is designed to actuate the special solenoid valve and outlet valve associated with the at least one of the wheel brakes at least in a selected braking mode in such a way that brake fluid is simultaneously discharged from the at least one wheel brake via the associated special solenoid valve and the associated outlet valve.

4. The driving dynamics system according to claim 1, further comprising:
at least one second pressure supply unit comprising a piston-cylinder unit or a rotary pump, which is arranged to provide brake fluid at least at one inlet of the at least one first pressure supply unit for a first brake circuit and a second brake circuit, wherein at least one isolating valve is provided for isolating the first brake circuit and/or the second brake circuit.

5. The driving dynamics system according to claim 1, wherein the at least one first pressure supply unit is directly connected to exactly two wheel brakes of the at least two hydraulically actuable wheel brakes, wherein the exactly two wheel brakes are configured to brake wheels on a first axle, and/or wherein a further pressure supply unit is provided, which is directly connected to at least two of the at least two hydraulically actuable wheel brakes on a second axle.

6. The driving dynamics system according to claim 1, wherein the special solenoid valve is designed to be open when de-energized and is arranged in such a way that a valve seat of the special solenoid valve is directly [D)] connected to at least one of the at least two hydraulically actuable wheel brakes.

7. The driving dynamics system according to claim 1, wherein the primary control unit is designed to detect a failure of at least one wheel brake circuit, comprising one of the at least two hydraulically actuable wheel brakes, and to close the special solenoid valve assigned to the at least one of the at least two hydraulically actuable wheel brakes in order to disconnect the wheel brake circuit.

8. The driving dynamics system according to claim 1, wherein the first pressure supply unit comprises a rotary pump which is connected to at least one of the at least two hydraulically actuable wheel brakes, and which is designed to build up and reduce pressure in the at least one of the at least two hydraulically actuable wheel brakes.

9. The driving dynamics system according to claim 4, wherein a special solenoid valve is assigned to at least one of the at least one second pressure supply unit and, is arranged in such a way that a valve seat of the special solenoid valve assigned to the second pressure supply unit of the at least one second pressure supply unit is directly connected to an/the inlet of the at least one first pressure supply unit.

10. The driving dynamics system according to claim 4 wherein at least one of the special solenoid valves is actuated during pressure reduction to provide a variable valve opening cross-section.

11. The driving dynamics system according to claim 1, wherein the first secondary control unit and/or at least one second secondary control unit and/or actuators of the at least one first pressure supply unit and/or at least one second pressure supply unit and/or sensors of the at least one first pressure supply unit and/or the at least one second pressure supply unit are communicatively connected to the primary control unit to enable implementation of steering commands and/or braking commands.

12. The driving dynamics system according to claim 11, characterized in that wherein the primary control unit is designed for the purpose(s) of:
implementing wheel brake-specific pressure control by activating at least one special solenoid valve of the at least one first pressure supply unit and/or the at least one second pressure supply unit,
and/or
detecting a wheel circuit failure by measuring pressure when a special solenoid valve associated with the at least one first pressure supply unit or an inlet valve is closed,
and/or
isolating a defective brake circuit by closing at least one isolating valve,
and/or
implementing an axle-by-axle anti-lock braking system ABS by controlling at least one isolating valves and alternating pressure build-up and pressure reduction via the at least one second pressure supply unit,
and/or
implementing a wheel-specific ABS by controlling at least one of the special solenoid valves and outlet valves of the at least one first pressure supply unit and by alternating pressure build-up and pressure reduction via the at least one second pressure supply unit,
and/or
distributing a braking torque generated by means of the at least one second pressure supply unit axle by axle by controlling a special solenoid valve assigned to the at least one second pressure supply unit during braking using the at least one electrical traction motor,
and/or
implementing automatic emergency braking by actuating the at least one electrical traction motors and at least the at least one first pressure supply unit in parallel.

13. The driving dynamics system according to claim 2, wherein the electromagnetic drive is designed redundantly with at least a first solenoid valve driver and a second solenoid valve driver, wherein the first secondary control unit is used for controlling the at least one special solenoid valve and is communicatively connected to the first solenoid valve driver and the primary control unit is used for controlling the at least one special solenoid valve and is communicatively connected to the second solenoid valve driver.

14. The driving dynamics system according to claim 1, wherein the primary control unit is designed to adjust, at least temporarily, a brake pressure at least in a selection of the at least two hydraulically actuable wheel brakes in a multiplex and/or piston pressure control method.

15. (canceled)

16. A method of adjusting a brake pressure in at least one wheel brake of a brake system via inlet valves configured to admit brake fluid into wheel brakes and outlet valves for discharging brake fluid from the wheel brakes, the method comprising:
determining that pressure is to be reduced from the at least wheel brakes;
selecting a pressure reduction mode from a first pressure reduction mode and a second pressure reduction mode;
when the first pressure reduction mode is selected, opening of at least one of the outlet valves associated with the at least one wheel brake to implement pressure reduction; and
when the second pressure reduction mode is selected, keeping the at least one of the outlet valves associated with the at least one wheel brake closed and opening at least one of the inlet valves associated with the at least one wheel brake and generating a differential pressure in a pressure supply unit to implement the pressure reduction from the at least one wheel brake via the at least one of the inlet valves.

17. A driving dynamics system for a vehicle with wheels, including:
a primary control unit configured to detect and/or generate steering and braking commands;
at least two hydraulically actuatable wheel brakes, each of which is associated associated with a respective one of the wheels;
at least one electrical traction motor having traction-motor control unit, wherein the at least one electrical traction motor is arranged to drive at least one of the wheels, wherein the primary control unit is communicatively connected to a traction-motor control unit to control the traction motor to implement the steering commands and braking commands;
at least one first electrohydraulic pressure supply unit comprising:
at least one electric motor-pump unit:
at least two connections to connect the at least one first electrohydraulic pressure supply unit to the hydraulically actuable wheel brakes;
electrically actuatable wheel brake pressure adjustment valves or brake pressure adjustment valves, and
a first secondary control unit;
wherein at least one of the hydraulically actuatable wheel brakes is associated with a brake pressure adjustment valve in the form of a special solenoid valve that is passive-closure-proof, and an outlet valve,
wherein the driving dynamics system, via the primary control unit, is designed to release pressure from at least one of the at least two hydraulically actuatable wheel brakes either via the associated outlet valve or via the associated special solenoid valve, and
wherein the primary control unit is configured to implement the method according to claim 16.
